(19) United States
(12) Patent Application Publication
(10) Pub. No.: US 2012/0262740 A1
(43) Pub. Date: Oct. 18, 2012

(54) IMAGE FORMING APPARATUS, METHOD, AND PROGRAM

(75) Inventor: Michihiko Yamada, Tsukubamirai-shi (JP)

(73) Assignee: CANON KABUSHIKI KAISHA, Tokyo (JP)

(21) Appl. No.: 13/439,833

(22) Filed: Apr. 4, 2012

(30) Foreign Application Priority Data
Apr. 13, 2011 (JP) 2011-088861

(51) Int. Cl. H04N 1/60; G06F 15/02

(52) U.S. Cl. 358/1.9

(57) ABSTRACT

An image forming apparatus comprising a receiving unit that receives a print command, an analyzing unit that analyzes the received print command, a converting unit that converts the received print command into CMYK when the analysis by the analyzing unit shows that a spot color is designated for the received print command, and an image forming unit that prints an image of the converted CMYK onto a recording paper and prints an image of CMYK obtained based on one of the received print commands for which no spot color is designated onto the recording paper.

### BACKGROUND OF THE INVENTION

1. Field of the Invention

The present invention relates to an image forming apparatus, a method, and a program which can print a spot color by CMYK.

2. Description of the Related Art

In the case where spot colors have individually been designated for, for example, company logos and the like, in general printers, a method is used where spot color ink adjusted by mixing a plurality of kinds of ink are formed and printing is performed by five or more colors including CMYK colors and at least one spot color. On the other hand, in electrophotographic printers generally used, only four colors of CMYK are generally used, wherein the spot color is separated into the CMYK colors, and the separated CMYK colors are overlaid onto recording paper, thereby expressing the spot color.

In the printers, a method called “color synthesis” is generally used in which the CMYK colors and the spot color are respectively formed and the formed colors are overlaid onto recording paper to print. In the electrophotographic printers, the CMYK colors and the spot color are respectively received and the spot color is separated into the CMYK colors. Such a method is attained by a function called “overprint” in which the separated CMYK colors are synthesized as signals of CMYK with other received colors of CMYK and toner images corresponding to the signals of the four colors of CMYK are synthesized onto the recording paper to print.

The electrophotographic printer is used as a simulation before the printing is performed by the printer or as a printer itself in a POD (Print On Demand) market. A reproduction of a spot color is attained by techniques such as reproduction by the CMYK toner of the spot color mentioned above and the foregoing overprint. On the other hand, in the overprint of the spot color in the related art, there is such a technique that a color management is performed to normal colors of CMYK and the overprint is performed to the spot color without performing a color management, thereby making an accurate color reproduction of the spot color (see, for example, Japanese Patent Application Laid-Open No. 2004-148535).

A processing result which is obtained by performing the overprint of a spot color by using the related art is illustrated in FIG. 16.

A case where when data of CMYK (normal colors)+spot color is processed, for example, if a spot color (1601) is separated into colors of CMYK, C=100% (1602) and Y=100% (1603) and it is intended to overprint the colors in which the normal colors of CMYK are Y=50% (1604) is now presumed.

In this case, since an overlapped portion (1605) of the spot color and the normal color cannot be printed in excess of Y=100% (1603), it becomes an overlapped portion (1606) expressed by C=100% and Y=100%.

If the printer has a function of printing a green spot color by green ink, in printed recording paper, since the green ink and yellow ink are formed, the overlapped portion (1605) is seen as if the yellow ink was overlaid onto the green ink. In the printing by the electrophotographic printer which has only the CMYK toner and executes the printing using four colors, there is such a problem that the printed recording paper is not seen as if the yellow ink was overlaid onto the green ink.

FIG. 16 is a diagram for describing a case where a spot color is separated into CMYK and the separated CMYK colors are synthesized with a normal color (any one of the CMYK colors or a color shown by a combination thereof).

### SUMMARY OF THE INVENTION

It is an object of the invention to solve the foregoing problems.

To solve the above problems, the present invention provides with an image forming apparatus comprising a receiving unit configured to receive a print command, an analyzing unit configured to analyze the print command received by the receiving unit, a converting unit configured to convert the received print command into CMYK when the analysis by the analyzing unit shows that a spot color is designated for the received print command, and an image forming unit configured to print an image of the CMYK converted by the converting unit onto a recording paper and to print an image of CMYK obtained based on one of the received print commands for which no spot color is designated onto the recording paper.

Further features of the present invention will become apparent from the following description of exemplary embodiments with reference to the attached drawings.

### BRIEF DESCRIPTION OF THE DRAWINGS

FIG. 1 is a diagram for describing a system construction as an embodiment of the invention.

FIG. 2 which is composed of FIGS. 2A and 2B are flowcharts illustrating a flow which is executed until an image is printed after data was received as an embodiment of the invention.

FIG. 3 is a diagram for describing a system construction as an an embodiment of the invention.

FIG. 4 which is composed of FIGS. 4A and 4B are flowcharts illustrating a flow which is executed until an image is printed after data was received as an embodiment of the invention.

FIG. 5 is a diagram for describing a system construction as an embodiment of the invention.

FIG. 6 which is composed of FIGS. 6A and 6B are flowcharts illustrating a flow which is executed until an image is printed after data was received as an embodiment of the invention.

FIG. 7 is a diagram for describing a system construction as an embodiment of the invention.

FIG. 8 which is composed of FIGS. 8A and 8B are flowcharts illustrating a flow which is executed until an image is printed after data was received as an embodiment of the invention.

FIG. 9 is a diagram for describing a system construction as an embodiment of the invention.

FIG. 10 which is composed of FIGS. 10A and 10B are flowcharts illustrating a flow which is executed until an image is printed after data was received as an embodiment of the invention.

FIG. 11 is a diagram illustrating an example of a state transition of an image as an embodiment of the invention.

FIG. 12 is a diagram illustrating an example of a state transition of an image as an embodiment of the invention.

FIG. 13 is a diagram illustrating an example of a state transition of an image as an embodiment of the invention.

FIG. 14 is a diagram illustrating an example of a state transition of an image as an embodiment of the invention.

FIG. 15 is a diagram illustrating an example of a state transition of an image as an embodiment of the invention.

FIG. 16 is a diagram illustrating an example of a state transition of an image in the related art.

FIG. 17 is a diagram illustrating a drawing example of a PDL command as an embodiment of the invention.

FIG. 18 is a diagram for describing a construction of a PDL command as an embodiment of the invention.

FIG. 19 is a diagram for describing a construction of a PDL command as an embodiment of the invention.

FIG. 20 is a diagram for describing a construction of a PDL command as an embodiment of the invention.

FIG. 21 is a diagram for describing a construction of a PDL command as an embodiment of the invention.

FIG. 22 is a diagram for describing a construction of a PDL command as an embodiment of the invention.

FIG. 23 is a diagram for describing a construction of a PDL command as an embodiment of the invention.

FIG. 24 is a diagram for describing a construction of a PDL command as an embodiment of the invention.

FIG. 25 is a diagram illustrating an example of a spot color list as an embodiment of the invention.

FIG. 26 is a diagram illustrating an example of a management list of an ID and a job as an embodiment of the invention.

FIG. 27 is a diagram for describing a construction of a PDL command as an embodiment of the invention.

FIG. 28 is a diagram illustrating an example of a user interface as an embodiment of the invention.

FIG. 29 is a diagram illustrating an example of a user interface as an embodiment of the invention.

### DESCRIPTION OF THE EMBODIMENTS

The invention relates to an image process for expressing a spot color by a combination of CMYK. Exemplary embodiments of the invention will now be described hereinbelow with reference to the drawings. In the following description, “PDL command” is a print command for instructing the printer to perform a drawing in a PDL (Page Description Language).

### First Embodiment

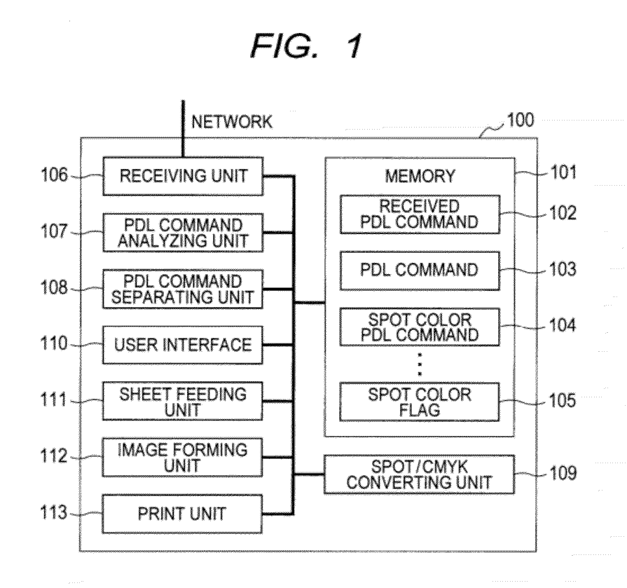

An image processing apparatus according to the first embodiment of the invention will be described. FIG. 1 is a system constructional diagram of the embodiment.

A system 100 is constructed by a memory 101, a receiving unit 106, a PDL command analyzing unit 107, a PDL command separating unit 108, a spot/CMYK converting unit 109, a user interface 110, a sheet feeding unit 111, an image forming unit 112, and a print unit 113. The memory 101 has a plurality of PDL command storing units. That is, the memory 101 has a received PDL command area 102 for storing a received PDL command, a PDL command area 103 for storing a separated PDL command, and a spot color PDL command area 104 for storing a PDL command consisting of a separated spot color. The memory 101 further has a spot color flag area 105 for showing whether or not the spot color is included in the received PDL command. The receiving unit 106 receives the PDL command through a network. The PDL command analyzing unit 107 analyzes the received PDL command. The PDL command separating unit 108 separates the received PDL command into the spot color and the other colors. The spot/CMYK converting unit 109 divides the spot color into one or more colors among the CMYK colors. The user interface 110 receives an instruction from the user. The sheet feeding unit 111 receives a print sheet. The image forming unit 112 forms print data from the PDL command or spot color PDL command. The print unit 113 prints an image formed by the image forming unit.

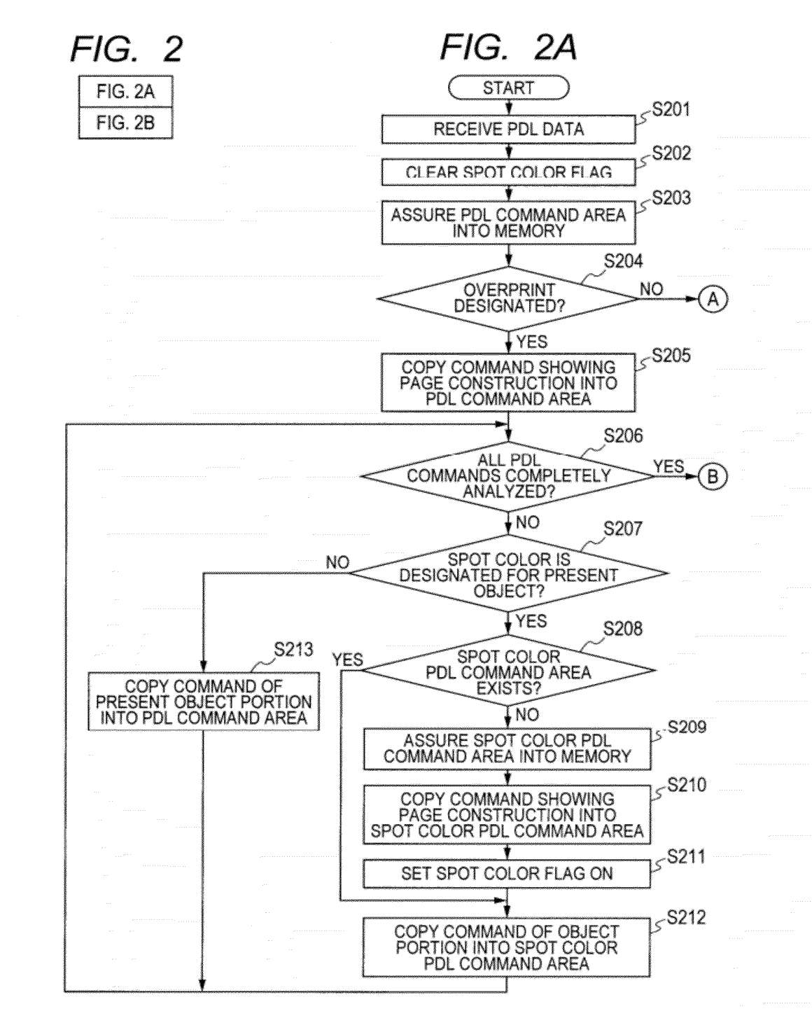

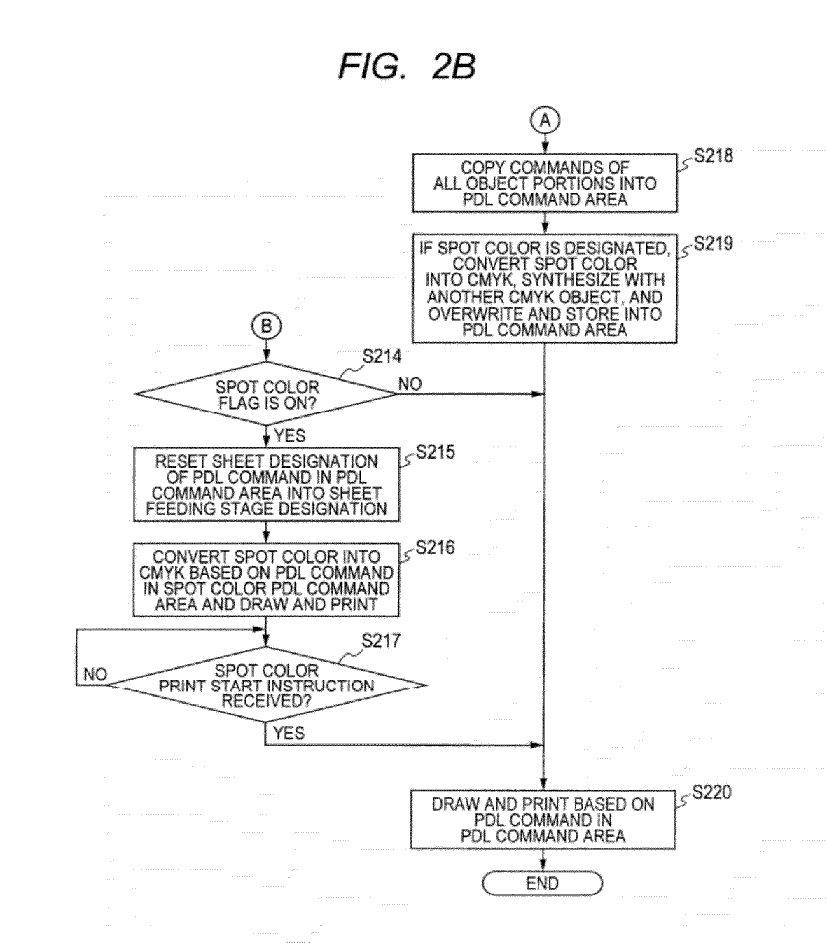

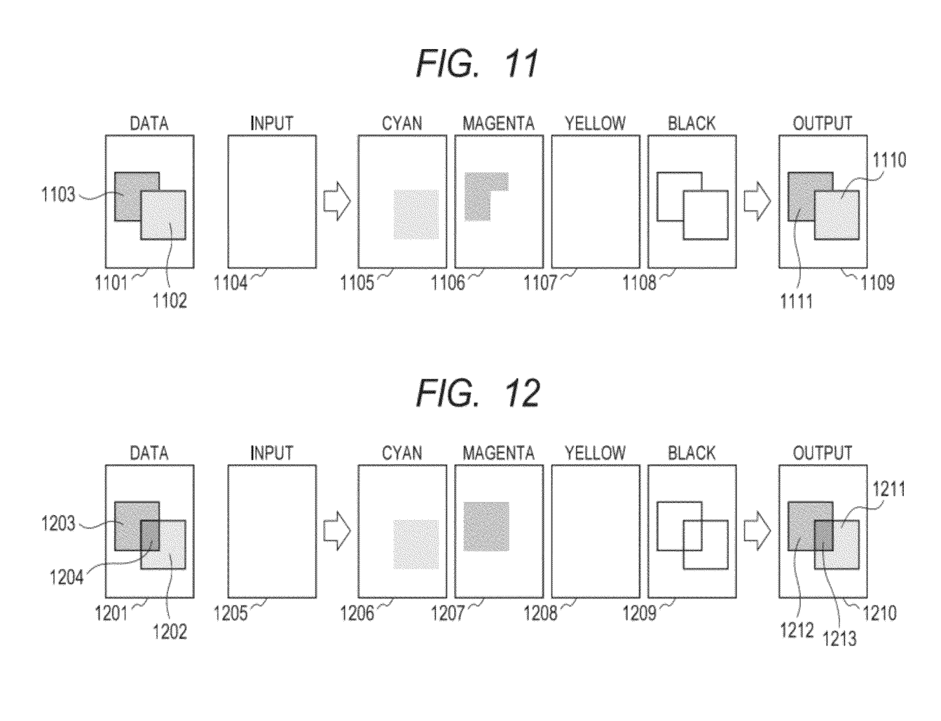

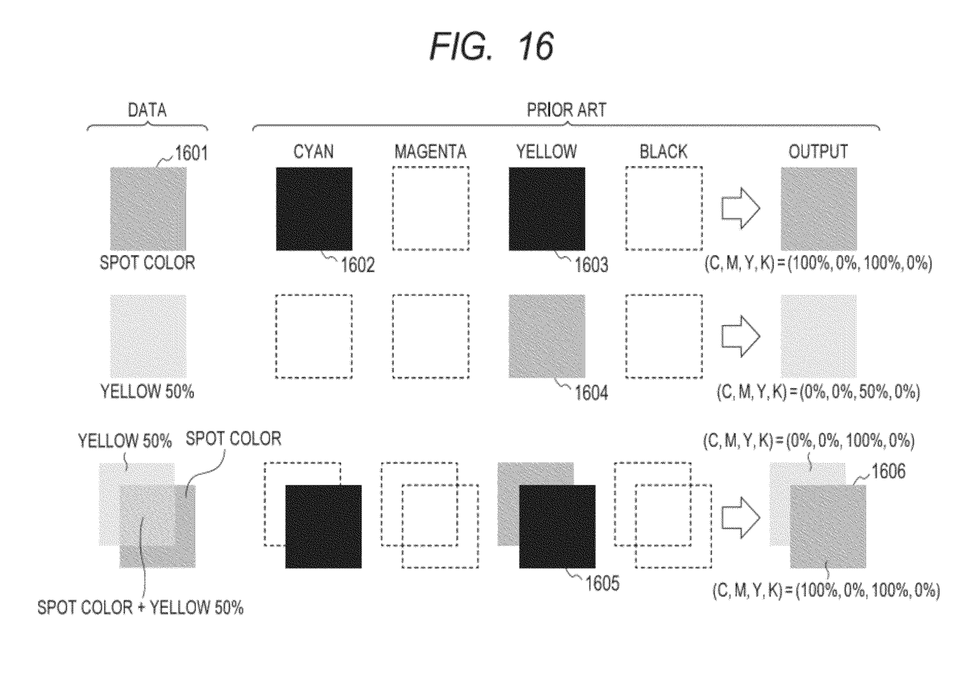

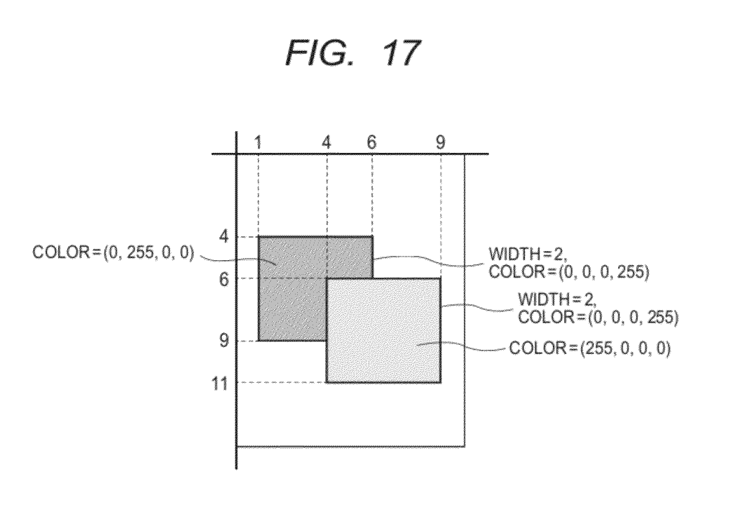

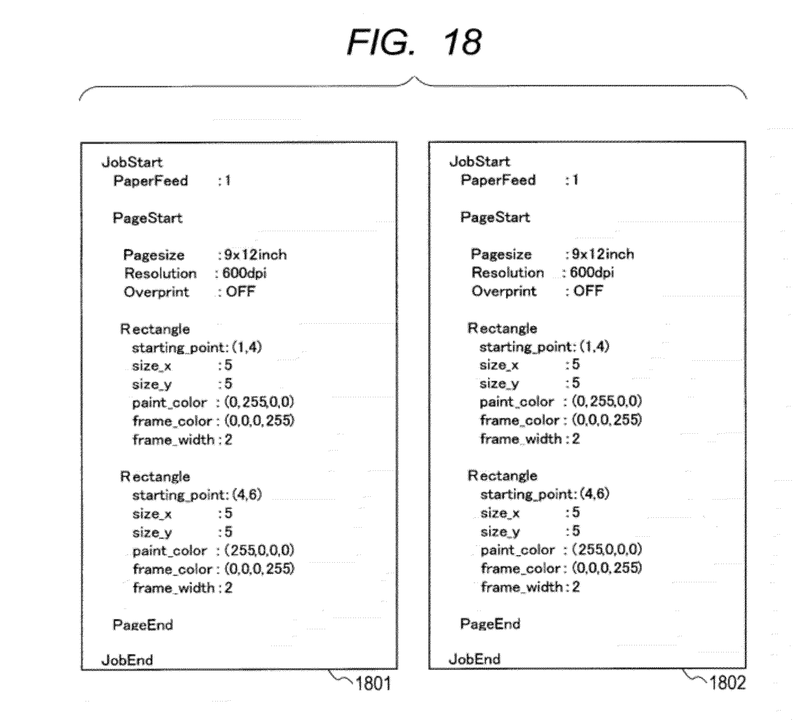

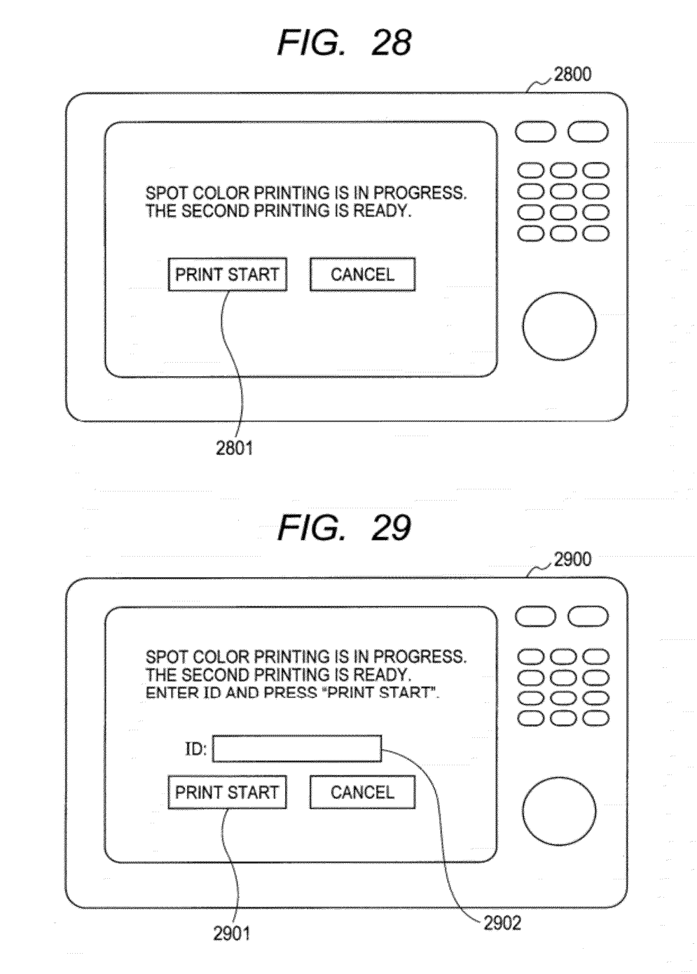

FIGS. 2A and 2B are flowcharts illustrating a flow which is executed until data is printed by the print unit 113 after the receiving unit 106 received the PDL command. The system 100 executes processes in FIGS. 2A and 2B. FIGS. 11 to 15 are diagrams for describing a change in image in the flow of those processes. FIG. 17 is a diagram for describing a drawing diagram of a PDL command 1801. FIGS. 18 to 21 are diagrams for describing a change in PDL command in the flow of those processes. FIG. 28 is a diagram for describing a user interface for promoting the user to perform the printing of the second time.

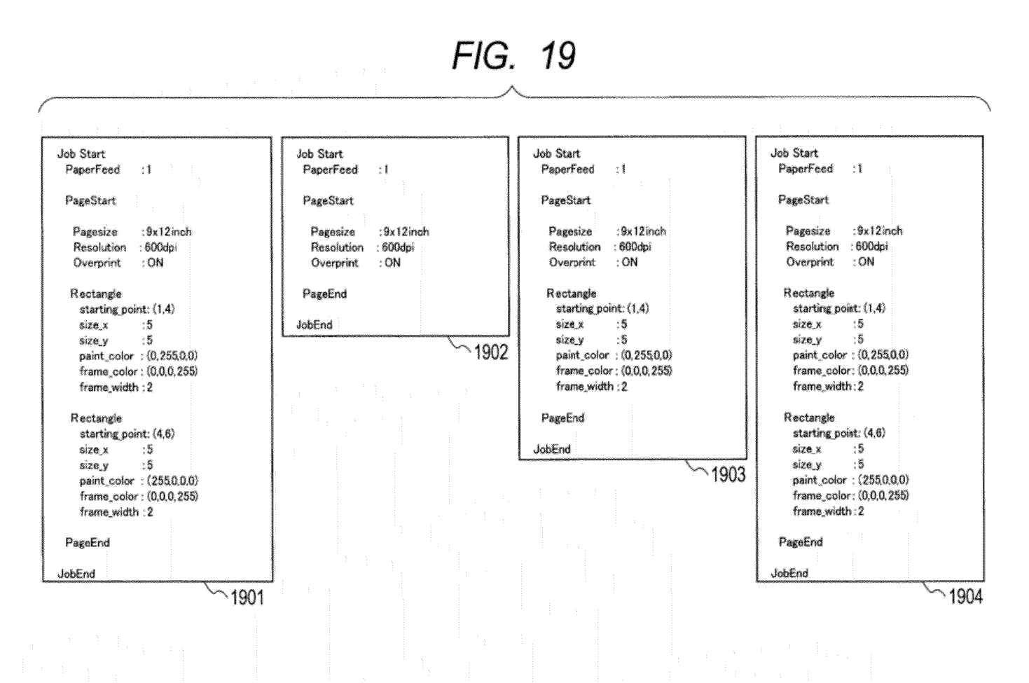

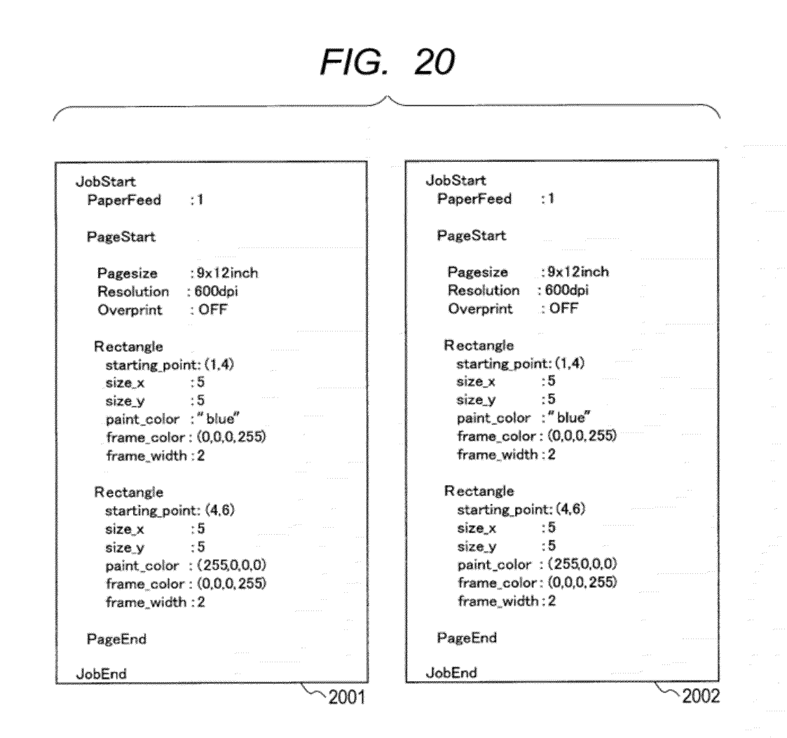

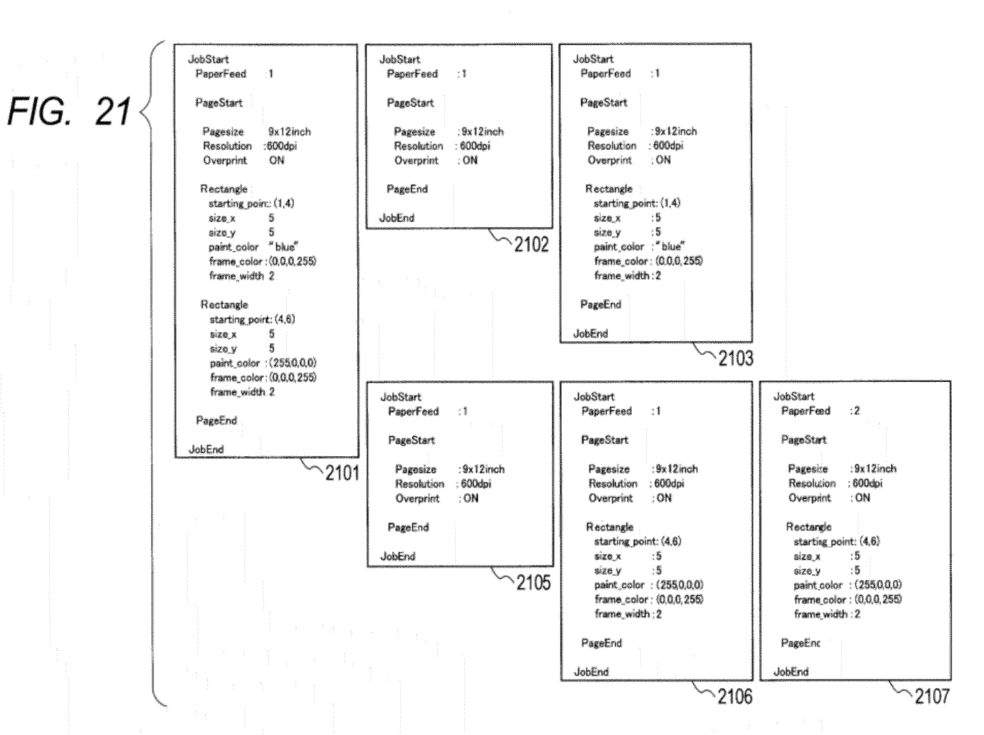

In step S201 in FIGS. 2A and 2B, the PDL command is received by the receiving unit 106, the received PDL command is stored into the received PDL command area 102 in the memory 101, and the processing routine advances to step S202. At this time, one of PDL commands 1801 (FIG. 18), 1901 (FIG. 19), 2001 (FIG. 20), and 2101 (FIG. 21) has been stored in the received PDL command area 102. In step S202, the spot color flag 105 in the memory 101 is cleared and step S203 follows. In step S203, the PDL command area 103 is assured in the memory 101 and step S204 follows.

In step S204, the received PDL command stored in the received PDL command area is analyzed by the PDL command analyzing unit 107, whether or not the overprint has been designated is confirmed, and if the overprint has been designated, step S205 follows. That is, if “Overprint” in one of the PDL commands 1801, 1901, 2001, and 2101 stored in the received PDL command area 102 is “ON”, step S205 follows. In step S205, the received PDL command stored in the received PDL command area is analyzed by the PDL command analyzing unit 107, the command showing a construction of a page is copied into the assured PDL command area 103, and step S206 follows. At this time, one of PDL commands 1902 and 2105 has been stored in the PDL command area 103. In step S206, whether or not all of the received PDL commands stored in the received PDL command area have completely been analyzed by the PDL command analyzing unit 107 is confirmed. If all of the received PDL commands are not analyzed yet, step S207 follows.

In step S207, whether or not the spot color has been designated for the present object which is being analyzed is discriminated. If the spot color has been designated, step S208 follows. In step S208, whether or not the spot color PDL command area has already been assured in the memory 101 is confirmed. If it is not assured yet, step S209 follows. In step S209, the spot color PDL command area 104 is assured in the memory 101 and step S210 follows. In step S210, the received PDL command stored in the received PDL command area is analyzed by the PDL command analyzing unit 107, the command showing the page construction is copied into the assured spot color PDL command area 104, and step S211 follows. A PDL command 2102 has been stored in the spot color PDL command area 104.

In step S211, the spot color flag 105 in the memory 101 is set to ON and step S212 follows. In step S212, the command in the object portion which is at present being analyzed is copied into the spot color PDL command area 104 by the PDL command separating unit 108. The processing routine is returned to step S206 and the processes are repeated. At this time, a PDL command 2103 has been stored in the spot color PDL command area 104.

In step S208, if the spot color PDL command area 104 has already been assured in the memory 101, step S212 follows. In step S207, if the spot color is not designated for the present object which is being analyzed, step S213 follows. In step S213, the command in the object portion which is at present being analyzed is copied into the PDL command area 103 by the PDL command separating unit 108. The processing routine is returned to step S206 and the processes are repeated. At this time, a PDL command 2106 has been stored in the PDL command area 103.

In step S206, if all of the received PDL commands have completely been analyzed, step S214 follows. In step S214, whether or not the spot color flag in the memory 101 is ON is discriminated. If the spot color flag is ON, step S215 follows. At this time, data 1506 serving as a PDL command 2106 has been stored in the PDL command area 103 in the memory 101 and data 1505 serving as a PDL command 2103 has been stored in the spot color PDL command area 104, respectively.

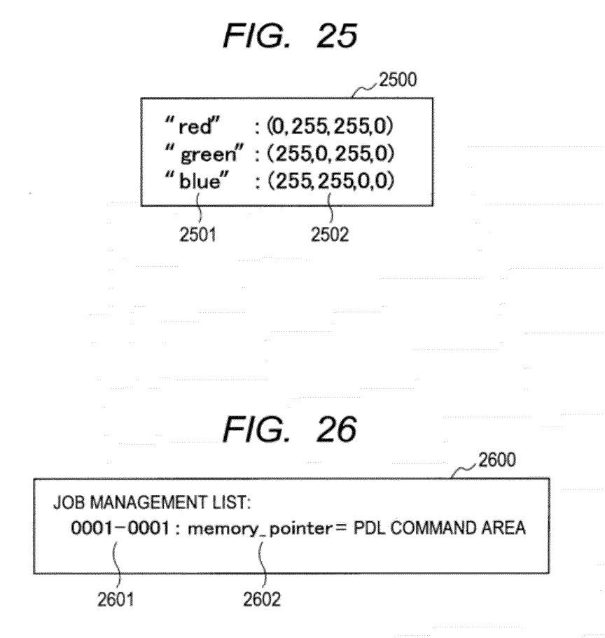

In step S215, a sheet designation of the PDL command in the PDL command area 103 in the memory 101 is reset into a sheet feeding stage designation and step S216 follows. At this time, the sheet feeding stage designation “PaperFeed” of the PDL command 2106 in the PDL command area 103 is changed from “1” to “2” and stored as a PDL command 2107. In step S216, the spot color of the spot color PDL command area 104 is converted into a combination of CMYK by the spot/CMYK converting unit 109 on the basis of a spot color list 2500 of FIG. 25. Further, a print image is formed by the image forming unit 112 on the basis of the PDL command and is printed (toner images of CMYK which have been converted are transferred and fixed) by the print unit 113, and step S217 follows. At this time, the data 1505 is converted into a cyan color 1508, a magenta color 1509, a yellow color 1510, and a black color 1511 and an output result 1512 is obtained. The output result 1512 is a printed matter in which toner images corresponding to the cyan color 1508, magenta color 1509, yellow color 1510, and black color 1511 have been printed onto recording paper.

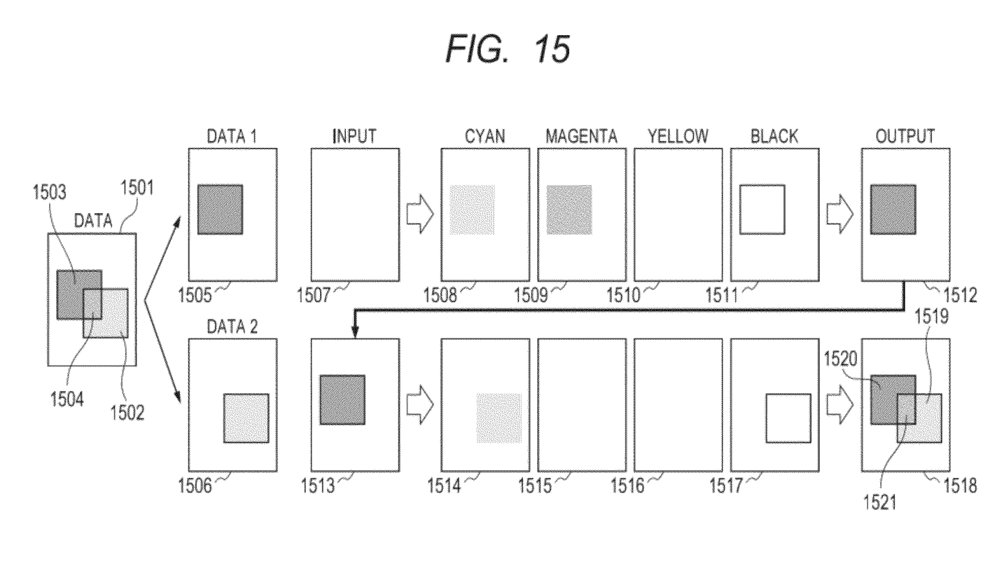

In step S217, a spot color print start button 2801 (FIG. 28) is displayed to the user interface 110 and whether or not the output result 1512 has been set to the sheet feeding stage “2” of the sheet feeding unit 111 and the spot color print start button 2801 has been depressed is confirmed. If NO, this process is repeated. On the other hand, if the output result 1512 has been set to the sheet feeding stage “2” and the spot color print start button 2801 has been depressed in step S217, step S220 follows. In step S220, a print image is formed by the image forming unit 112 on the basis of the PDL command 2107 in the PDL command area 103 in the memory 101 and is printed by the print unit 113, and the processing routine is finished. At this time, the data 1506 is expressed by a cyan color 1514, a magenta color 1515, a yellow color 1516, and a black color 1517 and an output result 1518 printed onto the output result 1512 existing in the sheet feeding unit 111 is obtained (FIG. 15). That is, toner images corresponding to the cyan color 1514, magenta color 1515, yellow color 1516, and black color 1517 are formed onto the output result 1512 and the output result 1518 is obtained. Therefore, the output result 1518 is constructed by a spot color area 1520, a normal color area 1519, and an area 1521 in which both of those areas are overlaid. In order to precisely position images which are obtained by the printing of two times, the apparatus is constructed in such a manner that a sensor (not shown) is provided for the sheet feeding unit 111 and a position of paper which is fed can be precisely confirmed. If the position of the fed paper can be precisely confirmed, an image can be formed at a desired position on the paper.

In step S214, if the spot color flag is OFF, step S220 follows. At this time, a process in which although the overprint has been designated, no spot color is contained is executed and an overprint of both normal colors in FIG. 12 is performed. In this instance, data 1201 (FIG. 12) expressed by a PDL command 1904 (FIG. 19) has been stored in the PDL command area 103. An image of a cyan color 1206, a magenta color 1207, a yellow color 1208, and a black color 1209 is formed by the image forming unit, toner images of the respective colors are printed by the print unit 113 onto an input sheet 1205 which is fed from the sheet feeding unit 111, and an output result 1210 is obtained. The output result 1210 is constructed by normal colors 1212 and 1211 and an area 1213 in which both of those colors are overlaid.

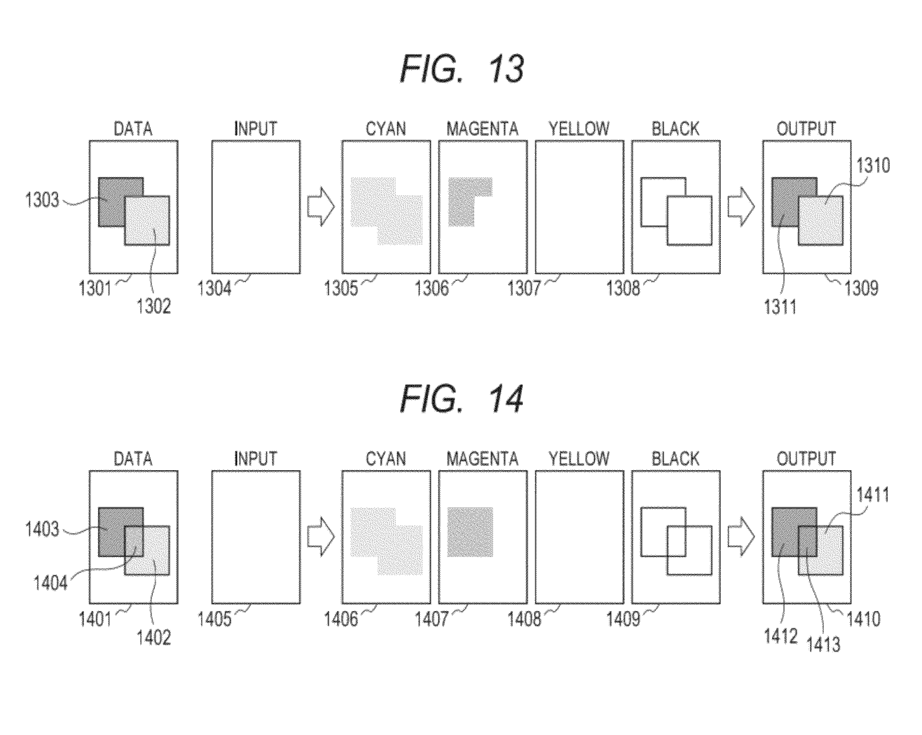

If it is determined in step S204 that the overprint is not designated, step S218 follows. In step S218, commands of all object portions are copied into the PDL command area 103 in the memory 101 and step S219 follows. At this time, one of PDL commands 1802 and 2002 has been stored in the PDL command area 103. In step S219, if a spot color was designated in the PDL command stored in the PDL command area 103, the spot color is separated into a cyan color, a magenta color, a yellow color, and a black color by the spot/CMYK converting unit 109. The obtained CMYK colors are synthesized with an object of normal colors and are overwritten, and step S220 follows. At this time, data 1301 (FIG. 13) expressed by the PDL command 2002 (FIG. 20) has been stored in the PDL command area 103. An image of a cyan color 1305, a magenta color 1306, a yellow color 1307, and a black color 1308 is formed by the image forming unit, toner images of the respective colors are printed onto an input sheet 1304 by the print unit 113, and an output result 1309 is obtained. The output result 1309 is constructed by a spot color area 1311 and a normal color area 1310. Or, if no spot color is contained, nothing is executed in step S219. At this time, data 1101 (FIG. 11) expressed by the PDL command 1802 has been stored in the PDL command area 103. An image of a cyan color 1105, a magenta color 1106, a yellow color 1107, and a black color 1108 is formed by the image forming unit, toner images of the respective colors are printed onto an input sheet 1104 by the print unit 113, and an output result 1109 is obtained. The output result 1109 is constructed by normal colors 1111 and 1110.

FIG. 14 is a diagram illustrating an example of an output result in the case where the foregoing procedure is not executed but, first, the overprint has been designated and the object of the spot color is included. Data 1401 formed by the user is constructed by a spot color area 1403, a normal color area 1402, and an area 1404 in which both of those colors are overlaid. If those color areas are printed by a normal procedure, a print result is expressed by a cyan color 1406, a magenta color 1407, a yellow color 1408, and a black color 1409. By forming toner images corresponding to those colors and printing them, an output result 1410 is obtained. In the output result 1410, an overlapped portion 1413 of a spot color area 1412 and a normal color 1411 has the same color as that of the spot color area 1412, so that it cannot be reproduced by a color such as 1404 which is inherently desired.

### Second Embodiment

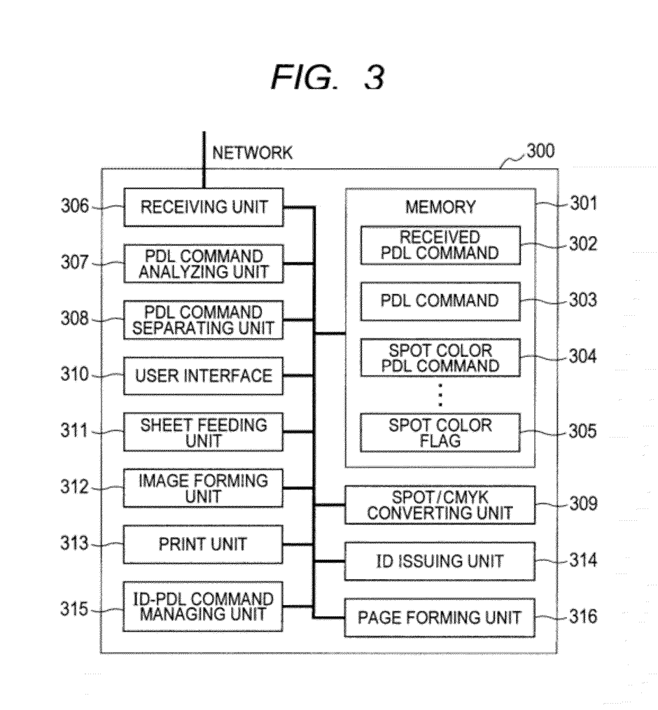

An image processing apparatus according to the second embodiment of the invention will be described. FIG. 3 is a system constructional diagram of the embodiment and is obtained by adding a function of managing a print job by an ID to the system of the first embodiment.

A system 300 is constructed by a memory 301, a receiving unit 306, a PDL command analyzing unit 307, a PDL command separating unit 308, a spot/CMYK converting unit 309, a user interface 310, a sheet feeding unit 311, an image forming unit 312, and a print unit 313. The system 300 further has an ID issuing unit 314, an ID-PDL command managing unit 315, and a page forming unit 316. The memory 301 has a received PDL command area 302 for storing a received PDL command, a PDL command area 303 for storing a separated PDL command, and a spot color PDL command area 304 for storing a PDL command consisting of a separated spot color. The memory 301 further has a spot color flag area 305 for showing whether or not the spot color is included in the received PDL command. The receiving unit 306 receives the PDL command through a network. The PDL command analyzing unit 307 analyzes the received PDL command. The PDL command separating unit 308 separates the received PDL command into the spot color and the other colors. The spot/CMYK converting unit 309 divides the spot color into one or more colors among the CMYK colors. The user interface 310 receives an instruction from the user. The sheet feeding unit 311 receives a print sheet. The image forming unit 312 forms print data from the PDL command or spot color PDL command. The print unit 313 prints an image formed by the image forming unit. The ID issuing unit 314 issues an ID. The ID-PDL command managing unit 315 manages the issued ID and the PDL command area 303 or the spot color PDL command area 304 in association with each other. The page forming unit 316 forms a page from the ID issued from the ID issuing unit 314.

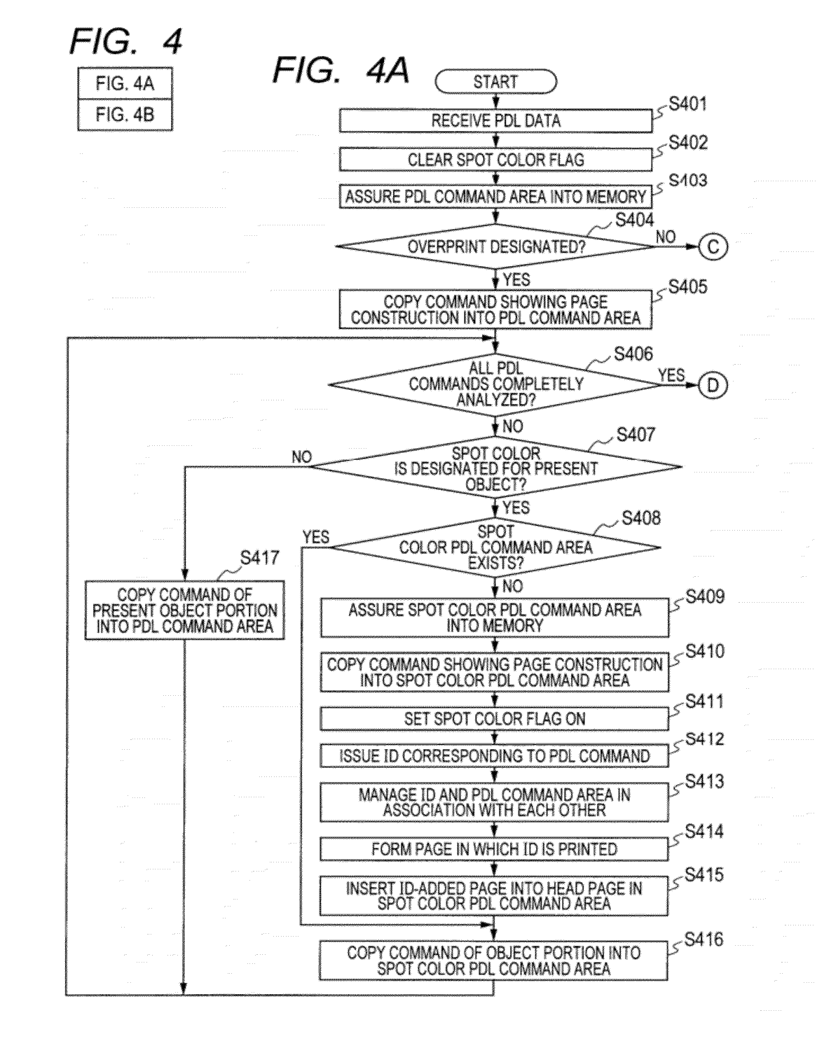

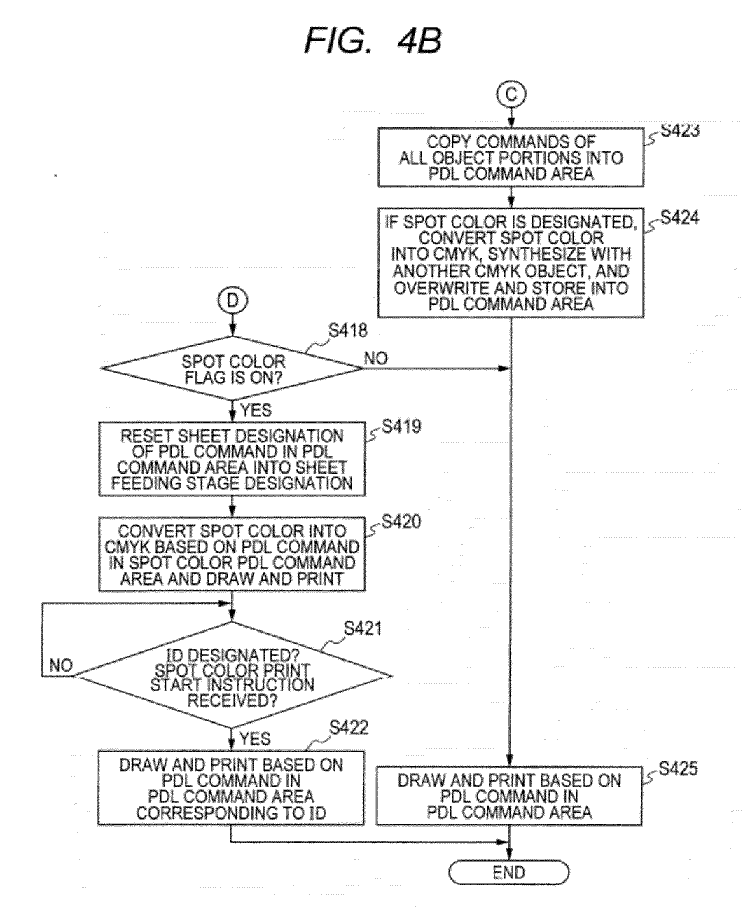

FIGS. 4A and 4B are flowcharts illustrating a flow which is executed until data is printed by the print unit 313 after the receiving unit 306 received the PDL command. The system 300 executes processes in FIGS. 4A and 4B. FIGS. 11 to 15 are the diagrams for describing a change in image in the flow of those processes. FIG. 17 is the diagram for describing the drawing diagram of the PDL command 1801. FIGS. 18 to 20 and 22 are the diagrams for describing a change in image in PDL command in the flow of those processes. FIG. 25 is a diagram for describing a reference list for converting a spot color into colors of C, M, Y, and K. FIG. 26 is a diagram for describing a job management list for managing the issued ID and the PDL in association with each other. FIG. 29 is a diagram for describing a user interface for promoting the user to input the ID for making the association of the printing and to perform the printing of the second time.

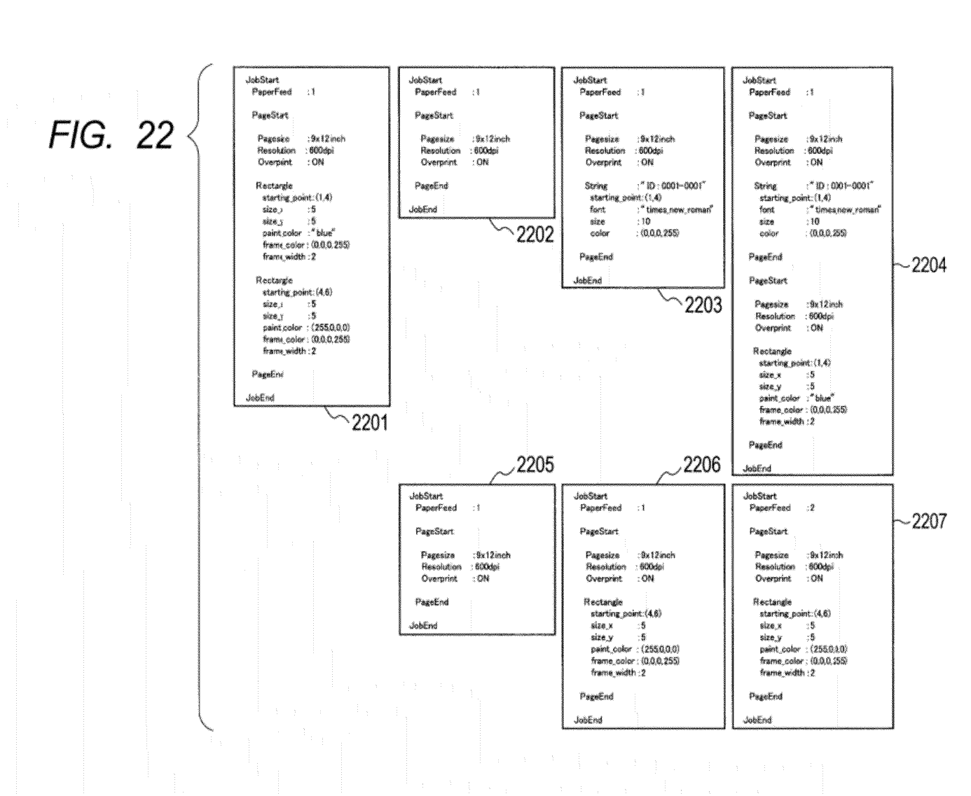

In step S401 in FIGS. 4A and 4B, the PDL command is received by the receiving unit 306 and is stored into the received PDL command area 302 in the memory 301, and the processing routine advances to step S402. At this time, one of PDL commands 1801 (FIG. 18), 1901 (FIG. 19), 2001 (FIG. 20), and 2201 (FIG. 22) has been stored in the received PDL command area 302. In step S402, the spot color flag 305 in the memory 301 is cleared and step S403 follows. In step S403, the PDL command area 303 is assured in the memory 301 and step S404 follows.

In step S404, the received PDL command stored in the received PDL command area is analyzed by the PDL command analyzing unit 307, whether or not the overprint has been designated is confirmed, and if the overprint has been designated, step S405 follows. That is, if “Overprint” in one of the PDL commands 1801, 1901, 2001, and 2201 stored in the received PDL command area 302 is “ON”, step S405 follows. In step S405, the received PDL command stored in the received PDL command area is analyzed by the PDL command analyzing unit 307, the command showing a construction of a page is copied into the assured PDL command area 303, and step S406 follows. At this time, one of PDL commands 1902 and 2205 has been stored in the PDL command area 303. In step S406, whether or not all of the received PDL commands stored in the received PDL command area have completely been analyzed by the PDL command analyzing unit 307 is confirmed. If all of the received PDL commands are not analyzed yet, step S407 follows.

In step S407, whether or not the spot color has been designated for the present object which is being analyzed is discriminated. If the spot color has been designated, step S408 follows. In step S408, whether or not the spot color PDL command area has already been assured in the memory 301 is confirmed. If it is not assured yet, step S409 follows. In step S409, the spot color PDL command area 304 is assured in the memory 301 and step S410 follows. In step S410, the received PDL command stored in the received PDL command area is analyzed by the PDL command analyzing unit 307, the command showing the page construction is copied into the assured spot color PDL command area 304, and step S411 follows. At this time, PDL command 2202 has been stored in the spot color PDL command area 304.

In step S411, the spot color flag 305 in the memory 301 is set to ON and step S412 follows. In step S412, the ID corresponding to the PDL command is issued by the ID issuing unit 314 and step S413 follows. The ID is expressed by a count value which is counted by a job counter and the number of spot colors and is used in order from the small number among available numbers. In step S413, the issued ID and the PDL command area 303 are managed in association with each other by the ID-PDL command managing unit 315 and step 414 follows. In the ID-PDL command managing unit 315, a management list 2600 of the job and the ID is formed and the ID and the memory in which the PDL command associated with the ID has been stored are associated.

In step S414, the page forming unit 316 forms a page from the issued ID and forms a PDL command, and step S415 follows. In step S415, the PDL command of the page including the issued ID is added to a head of the PDL command stored in the spot color PDL command area 304, is overwritten, and is stored, and step S416 follows. At this time, a PDL command 2203 has been stored in the spot color PDL command area 304. In step S416, the command in the object portion which is at present being analyzed is copied into the spot color PDL command area 304 by the PDL command separating unit 308. The processing routine is returned to step S406 and the processes are repeated. At this time, a PDL command 2204 has been stored in the spot color PDL command area 304.

In step S408, if the spot color PDL command area 304 has already been assured in the memory 301, step S416 follows. In step S407, if the spot color is not designated for the present object which is being analyzed, step S417 follows. In step S417, the command in the object portion which is at present being analyzed is copied into the PDL command area 303 by the PDL command separating unit 308. The processing routine is returned to step S406 and the processes are repeated. At this time, a PDL command 2206 has been stored in the PDL command area 303.

In step S406, if all of the received PDL commands have completely been analyzed, step S418 follows. In step S418, whether or not the spot color flag in the memory 301 is ON is confirmed. If the spot color flag is ON, step S419 follows. At this time, the data 1506 expressed by the PDL command 2206 has been stored in the PDL command area 303 in the memory 301 and the data 1505 expressed by the PDL command 2204 has been stored in the spot color PDL command area 304, respectively.

In step S419, the sheet designation of the PDL command in the PDL command area 303 in the memory 301 is reset into the sheet feeding stage designation and step S420 follows. At this time, a PDL command 2207 in which the sheet feeding stage designation “PaperFeed” of the PDL command 2206 has been changed from “1” to “2” is stored in the PDL command area 303. In step S420, the spot color of the spot color PDL command area 304 is converted into a combination of CMYK by the spot/CMYK converting unit 309 on the basis of the spot color list 2500. Further, a print image is formed by the image forming unit 312 on the basis of the PDL command and is printed (the toner images of CMYK which have been converted are transferred and fixed) by the print unit 313, and step S421 follows. Since the image is printed in response to the PDL command 2204, a page in which the ID has been written is printed to the first page, and a page of the spot color is printed to the second page. At this time, the data 1505 is converted into the cyan color 1508, magenta color 1509, yellow color 1510, and black color 1511 and the output result 1512 is obtained. The output result 1512 is a printed matter in which the toner images corresponding to the cyan color 1508, magenta color 1509, yellow color 1510, and black color 1511 have been printed onto the recording paper.

In step S421, a spot color print start button 2901 and an ID input window 2902 (FIG. 29) are displayed to the user interface 310. Further, whether or not the output result 1512 has been set into the sheet feeding stage of the sheet feeding unit 311, the correct ID has been input to the ID input window 2902, and the spot color print start button has been depressed is confirmed. If NO, this process is repeated. On the other hand, if the correct ID has been designated, the output result 1512 has been set to the sheet feeding stage of the sheet feeding unit 311, and the spot color print start button 2901 has been depressed in step S421, step S422 follows.

In step S422, an associated PDL command area is searched for from the input ID by the ID-PDL command managing unit 315 by using the management list of the ID and the job. Further, a print image is formed by the image forming unit 312 on the basis of the associated PDL command 2206 in the PDL command area 303 in the memory 301 and is printed by the print unit 313, and the processing routine is finished. At this time, the data 1506 expressed by the PDL command 2206 is expressed by the cyan color 1514, magenta color 1515, yellow color 1516, and black color 1517 and the output result 1518 printed onto the output result 1512 existing in the sheet feeding unit 311 is obtained. That is, the toner images corresponding to the cyan color 1514, magenta color 1515, yellow color 1516, and black color 1517 are formed onto the output result 1512 and the output result 1518 is obtained. Therefore, the output result 1518 is constructed by the spot color area 1520, normal color area 1519, and area 1521 in which both of those areas are overlaid.

In step S418, if the spot color flag is OFF, step S425 follows. In step S425, a print image is formed by the image forming unit 312 on the basis of the PDL command in the PDL command area 303 in the memory 301 and is printed by the print unit 313, and the processing routine is finished. At this time, a process in which although the overprint has been designated, no spot color is contained is executed. The PDL command 1904 has been stored in the PDL command area 303 and the overprint of both normal colors in FIG. 12 is performed. At this time, the data 1201 expressed by the PDL command 1904 has been stored in the PDL command area 303. An image of the cyan color 1206, magenta color 1207, yellow color 1208, and black color 1209 is formed by the image forming unit, toner images of the respective colors are printed by the print unit 313 onto the input sheet 1205 which is fed from the sheet feeding unit 311, and the output result 1210 is obtained. The output result 1210 is constructed by the normal colors 1212 and 1211 and the area 1213 in which both of those colors are overlaid.

If it is determined in step S404 that the overprint is not designated, step S423 follows. In step S423, commands of all object portions are copied into the PDL command area 303 in the memory 301 and step S424 follows. At this time, the PDL command 1802 or 2002 has been stored in the PDL command area 303. In step S424, if the PDL command 2002 (the spot color has been designated in the PDL command) has been stored in the PDL command area 303, the spot color is separated into a cyan color, a magenta color, a yellow color, and a black color by the spot/CMYK converting unit 309 on the basis of the spot color list 2500. The obtained CMYK colors are synthesized with an object of normal colors and are overwritten, and step S425 follows. At this time, the data 1301 expressed by the PDL command 2002 has been stored in the PDL command area 303. An image of the cyan color 1305, magenta color 1306, yellow color 1307, and black color 1308 is formed by the image forming unit, toner images of the respective colors are printed onto the input sheet 1304 by the print unit 313, and the output result 1309 is obtained. The output result 1309 is constructed by the spot color area 1311 and the normal color area 1310. Or, in the case of the PDL command 1802 corresponding to the case where no spot color is contained, nothing is executed in step S424. At this time, the data 1101 expressed by the PDL command 1802 has been stored in the PDL command area 303. An image of the cyan color 1105, magenta color 1106, yellow color 1107, and black color 1108 is formed by the image forming unit, toner images of the respective colors are printed onto the input sheet 1104 by the print unit 313, and the output result 1109 is obtained. The output result 1109 is constructed by the normal colors 1111 and 1110.

### Third Embodiment

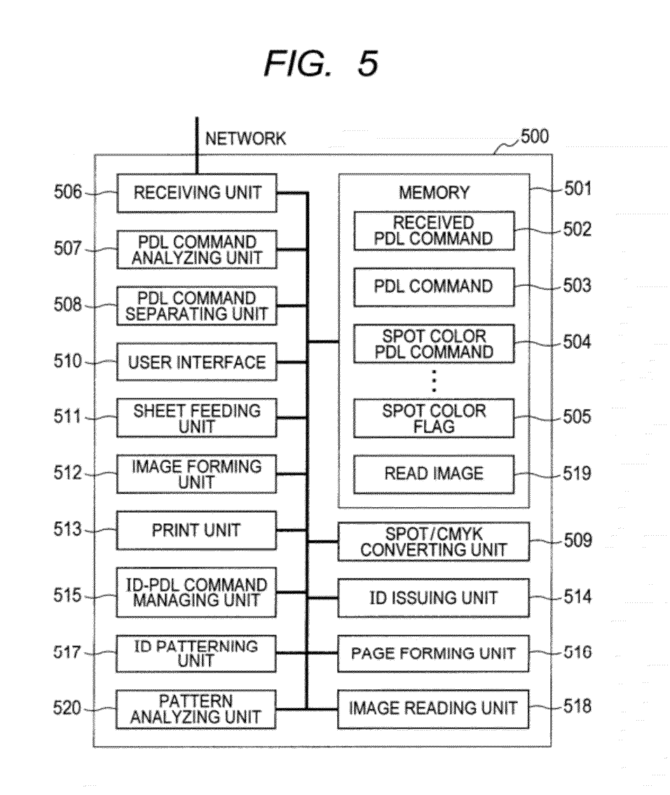

An image processing apparatus according to the third embodiment of the invention will be described. FIG. 5 is a system constructional diagram of the embodiment and illustrates an example in which the ID management of the job in the system of the second embodiment is executed by a method whereby a pattern is read by a reading apparatus instead of the input from the user interface.

A system 500 has component elements 506 to 513 and 502 to 505 corresponding to the foregoing component elements 306 to 313 and 302 to 305 in FIG. 3. The system 500 further has an ID patterning unit 517, an image reading unit 518, a pattern analyzing unit, and a read image area 519. Each of the component elements 506 to 514 has the same construction as that of each of the component elements 306 to 314 in FIG. 3. The ID patterning unit 517 patterns the ID issued from an ID issuing unit 514. A page forming unit 516 forms a page from the patterned ID. An image reading unit 518 reads the image. A pattern analyzing unit 520 analyzes the image read out by the image reading unit and analyzes a pattern if the pattern exists.

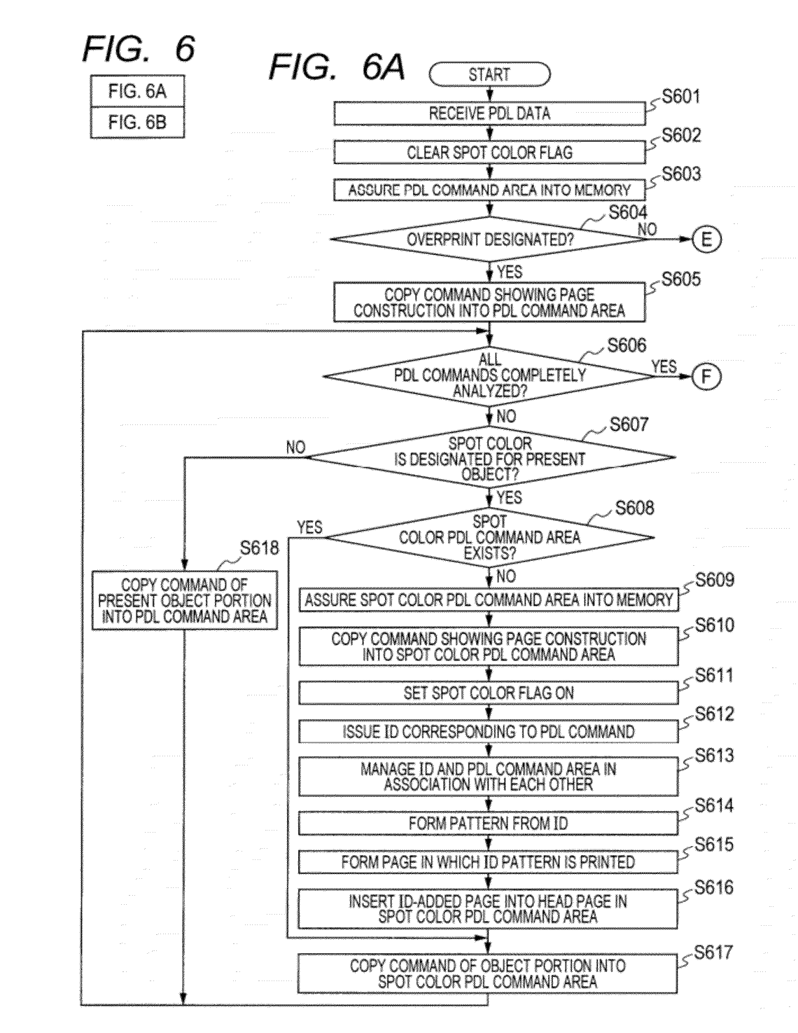

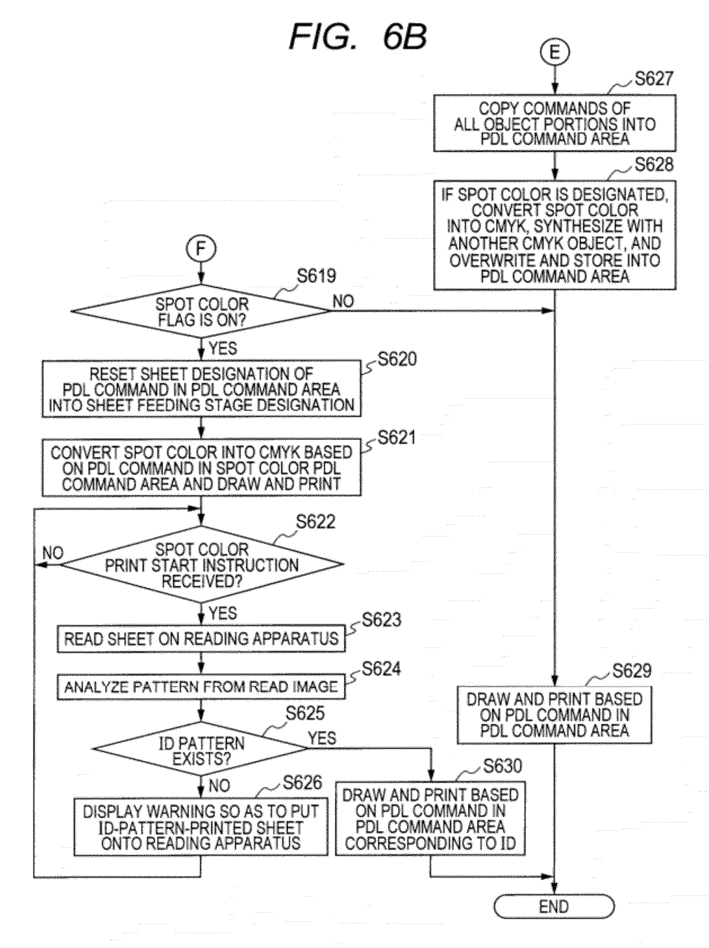

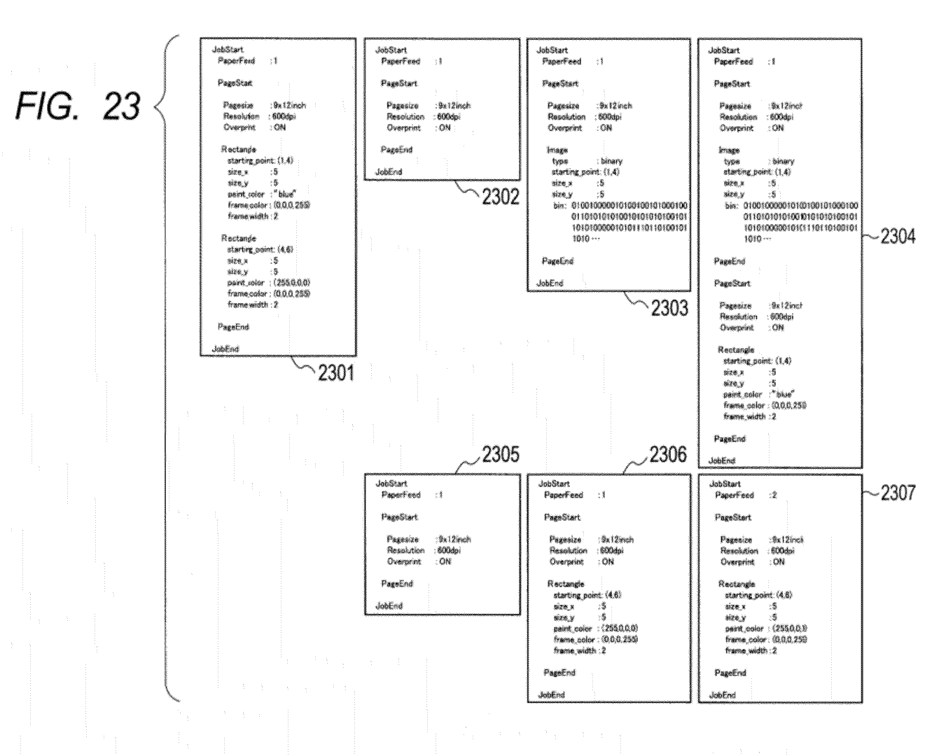

FIGS. 6A and 6B are flowcharts illustrating a flow which is executed until an image is printed after a receiving unit 506 received the PDL command. FIGS. 11 to 15 are the diagrams for describing a change in image in the processing flow. FIG. 17 is the diagram for describing a drawing diagram of the PDL command 1801. FIGS. 18 to 20 and 23 are the diagrams for describing a change in PDL command in the processing flow. FIG. 25 is the diagram for describing a reference list to convert the spot color into colors of C, M, Y, and K. FIG. 26 is the diagram for describing a job management list for allowing the issued ID and the PDL to be associated and managing them. FIG. 28 is the diagram for describing a user interface for promoting the user to perform the printing of the second time.

Since steps S601 to S613 in FIGS. 6A and 6B are the same as steps S401 to S413 in FIGS. 4A and 4B, their description is omitted here.

In step S614, the ID issued from the ID issuing unit 514 is patterned by the ID patterning unit 517 and step S615 follows. The ID pattern is constructed by an image of 1 bit. In step S615, the page forming unit 516 forms the page from the formed ID pattern and forms the PDL command, and step S616 follows. In step S616, the PDL command of the page including the issued ID is added to the head of the PDL command stored in a spot color PDL command area 504, is overwritten, and is stored, and step S617 follows. At this time, the PDL command 2303 has been stored in the spot color PDL command area 504. In step S617, the command in the object portion which is at present being analyzed is copied into the spot color PDL command area 504 by a PDL command separating unit 508. The processing routine is returned to step S606 and the processes are repeated. At this time, a PDL command 2304 has been stored in the spot color PDL command area 504.

In step S608, if the spot color PDL command area 504 has already been assured in a memory 501, step S617 follows. In step S607, if the spot color is not designated for the present object which is being analyzed, step S618 follows. In step S618, the command in the object portion which is at present being analyzed is copied into a PDL command area 503 by the PDL command separating unit 508. The processing routine is returned to step S606 and the processes are repeated. At this time, a PDL command 2306 has been stored in the PDL command area 503.

In step S606, if all of the received PDL commands have completely been analyzed, step S619 follows. In step S619, whether or not the spot color flag in the memory 501 is ON is confirmed. If the spot color flag is ON, step S620 follows. At this time, the data 1506 expressed by the PDL command 2306 has been stored in the PDL command area 503 in the memory 501 and the data 1505 expressed by the PDL command 2304 has been stored in the spot color PDL command area 504, respectively.

In step S620, the sheet designation of the PDL command in the PDL command area 503 in the memory 501 is reset into the sheet feeding stage designation and step S621 follows. A PDL command 2307 in which the sheet feeding stage designation “PaperFeed” of the PDL command 2306 has been changed from “1” to “2” is stored in the PDL command area 503. In step S621, the spot color of the spot color PDL command area 504 is converted into a combination of CMYK by a spot/CMYK converting unit 509 on the basis of the spot color list 2500. Further, a print image is formed by an image forming unit 512 on the basis of the PDL command and is printed (the toner images of CMYK which have been converted are transferred and fixed) by a print unit 513, and step S622 follows. Since the image in which the ID pattern has been drawn is printed to the first page and the page of the spot color is printed to the second page. At this time, the data 1505 expressed by the PDL command 2304 is converted into the cyan color 1508, magenta color 1509, yellow color 1510, and black color 1511 and the output result 1512 is obtained. The output result 1512 is a printed matter in which the toner images corresponding to the cyan color 1508, magenta color 1509, yellow color 1510, and black color 1511 have been printed onto the recording paper.

In step S622, the spot color print start button 2801 (FIG. 28) is displayed to a user interface 510. Further, whether or not the output result 1512 has been set into the sheet feeding stage of a sheet feeding unit 511, the sheet on which the ID pattern was printed has correctly been set into the image reading unit 518, and the spot color print start button 2801 has been depressed is confirmed. If NO, this process is repeated. On the other hand, if the correct ID has been designated, the output result 1512 has been set to the sheet feeding stage, and the spot color print start button 2801 has been depressed in step S622, step S623 follows. In step S623, an image pattern of the sheet set into the image reading unit 518 is stored into a read image area 519 in the memory 501, and step S624 follows. In step S624, the image pattern stored in the read image area 519 is analyzed by the pattern analyzing unit 520, and step S625 follows.

In step S625, whether or not the ID pattern exists as a result of the pattern analysis is discriminated. If the ID pattern does not exist, step S626 follows. In step S626, such a warning as to allow the user to put the ID-pattern-printed sheet into the image reading unit 518 is displayed to the user interface 510. The processing routine is returned to step S622 and the processes are repeated. On the other hand, if the ID pattern exists in step S625, step S630 follows. In step S630, an associated PDL command area is searched for from the input ID by an ID-PDL command managing unit 515 by using the management list 2600 of the ID and the job. Further, a print image is formed by the image forming unit 512 on the basis of the associated PDL command 2307 in the PDL command area 503 in the memory 501 and is printed by the print unit 513, and the processing routine is finished. At this time, the data 1506 expressed by the PDL command 2307 is expressed by the cyan color 1514, magenta color 1515, yellow color 1516, and black color 1517 and the output result 1518 printed onto the output result 1512 existing in the sheet feeding unit 511 is obtained. That is, the toner images corresponding to the cyan color 1514, magenta color 1515, yellow color 1516, and black color 1517 are formed onto the output result 1512 and the output result 1518 is obtained. Therefore, the output result 1518 is constructed by the spot color area 1520, normal color area 1519, and area 1521 in which both of those areas are overlaid.

In step S619, if the spot color flag is OFF, step S629 follows. In step S629, a print image is formed by the image forming unit 512 on the basis of the PDL command in the PDL command area 503 in the memory 501 and is printed by the print unit 513, and the processing routine is finished. At this time, a process in which although the overprint has been designated, no spot color is contained is executed, and the overprint of both normal colors in FIG. 12 is executed. In this instance, the data 1201 expressed by the PDL command 1904 has been stored in the PDL command area 503. The image of the cyan color 1206, magenta color 1207, yellow color 1208, and black color 1209 is formed by the image forming unit, toner images of the respective colors are printed by the print unit 513 onto the input sheet 1205 which is fed from the sheet feeding unit 511, and the output result 1210 is obtained. The output result 1210 is constructed by the normal colors 1212 and 1211 and the area 1213 in which both of those colors are overlaid.

If it is determined in step S604 that the overprint is not designated, step S627 follows. In step S627, commands of all object portions are copied into the PDL command area 503 in the memory 501 and step S628 follows. In step S628, if the spot color has been designated in the PDL command stored in the PDL command area 503, the spot color is separated into a cyan color, a magenta color, a yellow color, and a black color by the spot/CMYK converting unit 509. The obtained CMYK colors are synthesized with an object of normal colors and are overwritten, and step S629 follows. At this time, the data 1301 expressed by the PDL command 2002 has been stored in the PDL command area 503. The image of the cyan color 1305, magenta color 1306, yellow color 1307, and black color 1308 is formed by the image forming unit, toner images of the respective colors are printed onto the input sheet 1304 by the print unit 513, and the output result 1309 is obtained. The output result 1309 is constructed by the spot color area 1311 and the normal color area 1310. Or, in the case where no spot color is contained, nothing is executed in step S628. At this time, the data 1101 expressed by the PDL command 1802 has been stored in the PDL command area 503. The image of the cyan color 1105, magenta color 1106, yellow color 1107, and black color 1108 is formed by the image forming unit, toner images of the respective colors are printed onto the input sheet 1104 by the print unit 513, and the output result 1109 is obtained. The output result 1109 is constructed by the normal colors 1111 and 1110.

### Fourth Embodiment

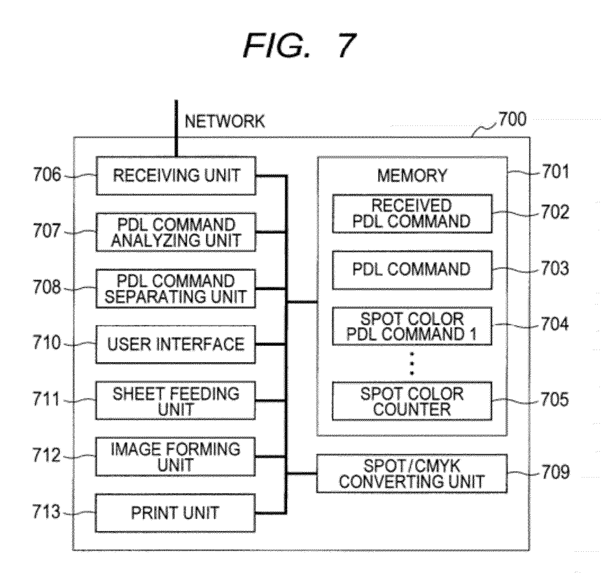

An image processing apparatus according to the fourth embodiment of the invention will be described. FIG. 7 is a system constructional diagram of the embodiment and illustrates an example in which the system of the first embodiment is made to correspond to the designation of a plurality of spot colors.

A system 700 has component elements 706 to 713 and 702 to 704 corresponding to the foregoing component elements 106 to 113 and 102 to 104 in FIG. 1. The memory 701 further has a spot color counter 705 for counting the number of spot colors contained in the received PDL command.

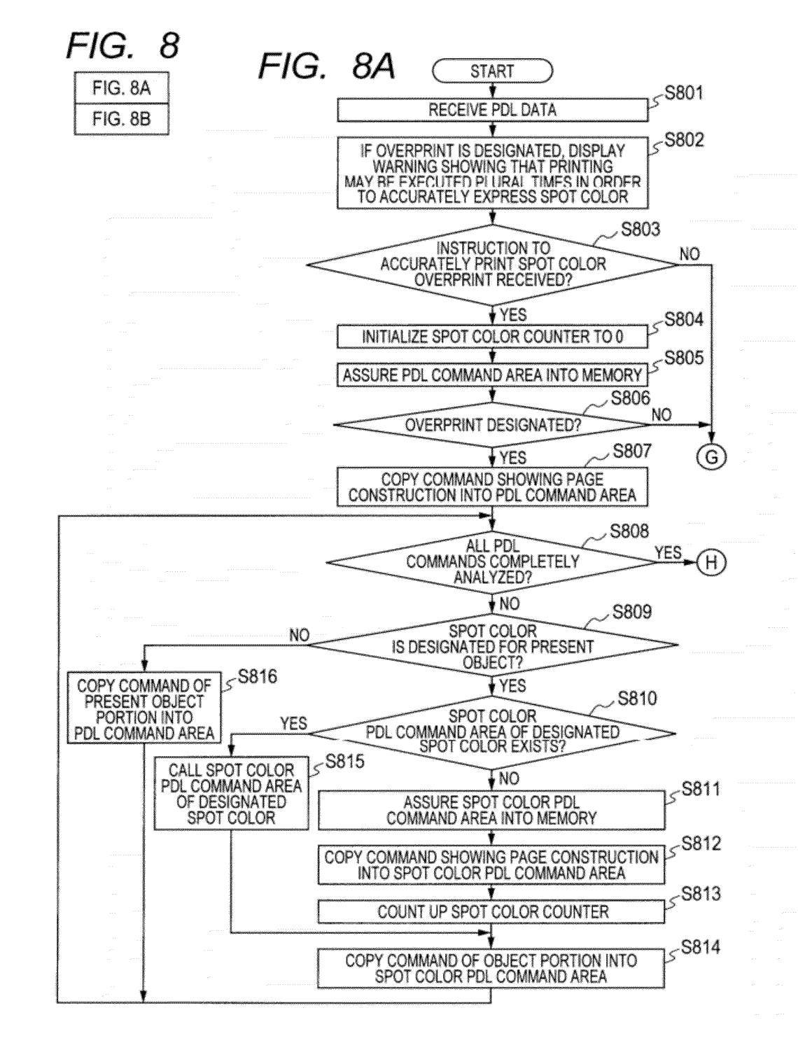

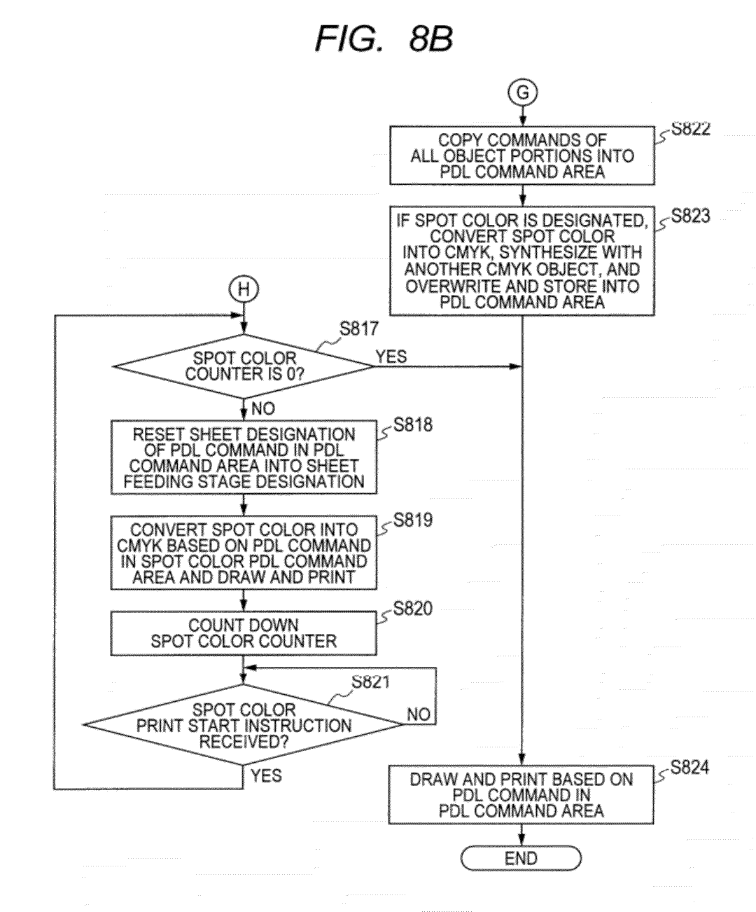

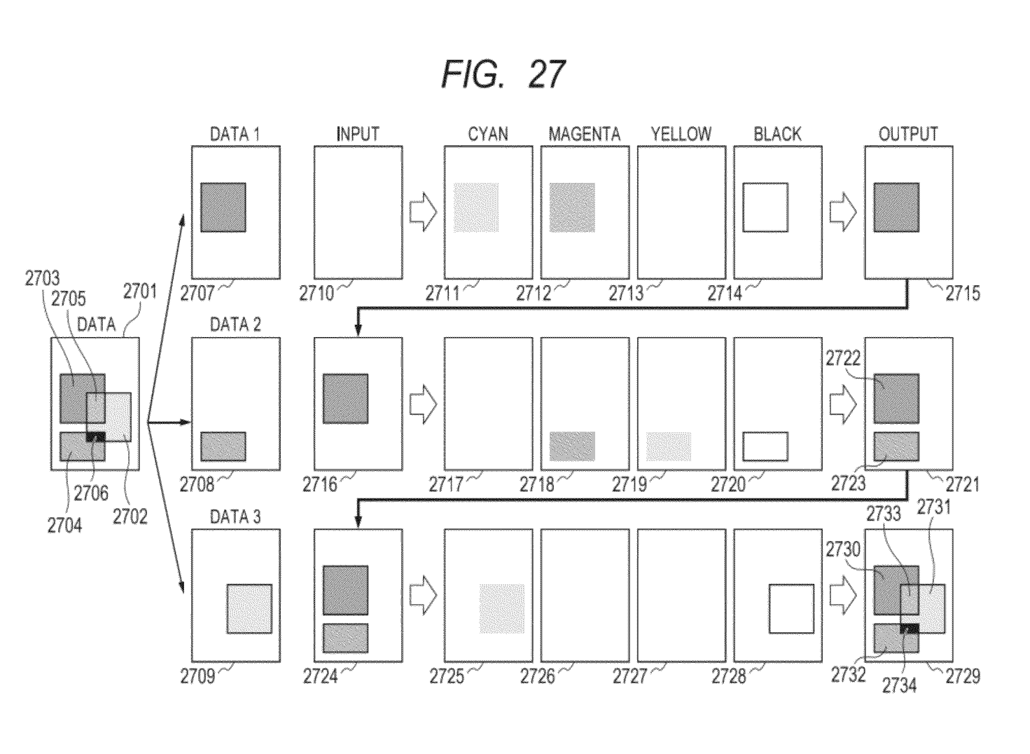

FIGS. 8A and 8B are flowcharts illustrating a flow which is executed until an image is printed by a print unit 713 after a receiving unit 706 received the PDL command. FIGS. 11 to 14 and 27 are the diagrams for describing a change in image in the processing flow. FIG. 17 is the diagram for describing the drawing diagram of the PDL command 1801. FIGS. 18 to 20 and 24 are the diagrams for describing a change in PDL command in the processing flow. FIG. 25 is the diagram for describing the reference list to convert the spot color into colors of C, M, Y, and K. FIG. 28 is the diagram for describing the user interface for promoting the user to perform the printing of the second time.

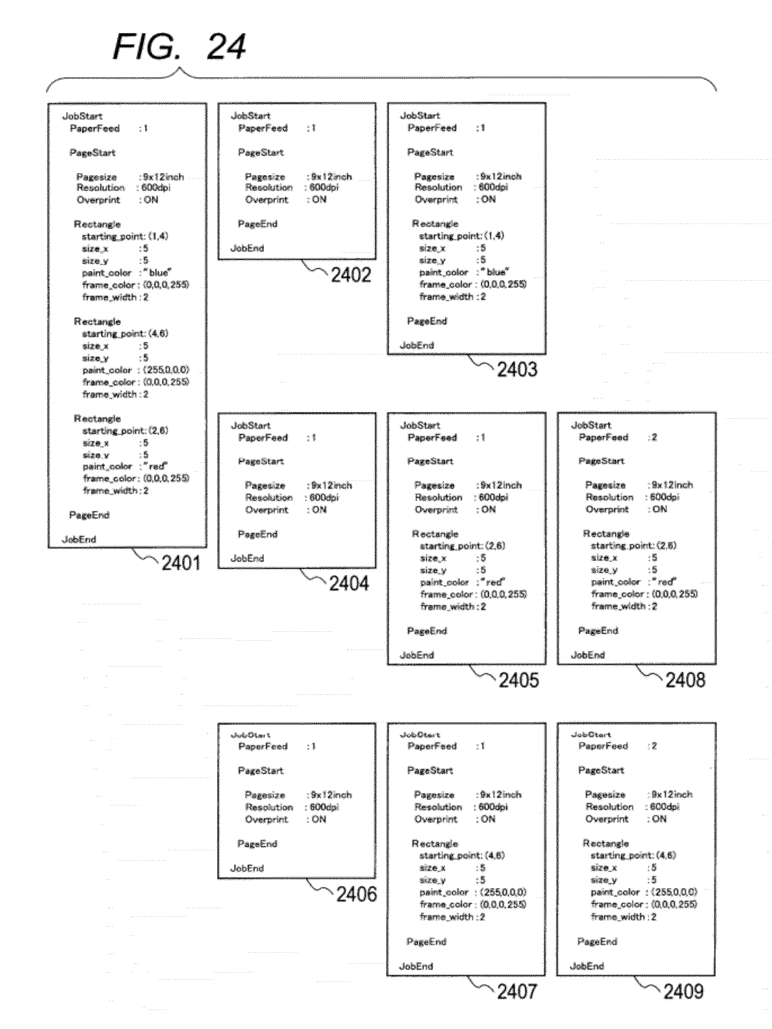

In step S801 in FIGS. 8A and 8B, the PDL command is received by the receiving unit 706, the received PDL command is stored into a received PDL command area 702 in a memory 701, and the processing routine advances to step S802. At this time, one of PDL commands 1801 (FIG. 18), 1901 (FIG. 19), 2001 (FIG. 20), and 2401 (FIG. 24) has been stored in the received PDL command area 702. In step S804, the spot color counter 705 in the memory 701 is initialized to zero and step S805 follows. In step S805, a PDL command area 703 is assured in the memory 701 and step S806 follows.

In step S806, the received PDL command stored in the received PDL command area is analyzed by a PDL command analyzing unit 707, whether or not the overprint has been designated is confirmed, and if the overprint has been designated, step S807 follows. That is, if “Overprint” in one of the PDL commands 1801, 1901, 2001, and 2401 stored in the received PDL command area 702 is “ON”, step S807 follows. In step S807, the received PDL command stored in the received PDL command area is analyzed by the PDL command analyzing unit 707, the command showing a construction of a page is copied into the assured PDL command area 703, and step S808 follows. At this time, one of PDL commands 1902 and 2406 has been stored in the PDL command area 703. In step S808, whether or not all of the received PDL commands stored in the received PDL command area have completely been analyzed by the PDL command analyzing unit 707 is confirmed. If all of the received PDL commands are not analyzed yet, step S809 follows.

In step S809, whether or not the spot color has been designated for the present object which is being analyzed is discriminated. If the spot color has been designated, step S810 follows. In step S810, whether or not the spot color PDL command area for the spot color which is at present being analyzed has already been assured in the memory 701 is confirmed. If it is not assured yet, step S811 follows. In step S811, a spot color PDL command area 704 is assured in the memory 701 and step S812 follows. In step S812, the received PDL command stored in the received PDL command area is analyzed by the PDL command analyzing unit 707, the command showing the page construction is copied into the assured spot color PDL command area 704, and step S813 follows. At this time, a PDL command 2402 has been stored in the spot color PDL command area 704. At the second time, a second spot color PDL command area is formed and a PDL command 2404 has been stored therein.

In step S813, the spot color counter 705 in the memory 701 is counted up by 1 and step S814 follows. In step S814, the command in the object portion which is at present being analyzed is copied into the spot color PDL command area 704 by a PDL command separating unit 708. The processing routine is returned to step S808 and the processes are repeated. At this time, a PDL command 2403 has been stored in the spot color PDL command area 704 and a PDL command 2405 has been stored in the second spot color PDL command area 704, respectively.

In step S810, if the spot color PDL command area 704 has already been assured in the memory 701, step S815 follows. In step S815, the spot color PDL command area for the spot color which is at present being analyzed is searched for and is set as a present spot color PDL command area, step S814 follows, and the processes are repeated.

In step S809, if the spot color is not designated for the present object which is being analyzed, step S816 follows. In step S816, the command in the object portion which is at present being analyzed is copied into the PDL command area 703 by the PDL command separating unit 708. The processing routine is returned to step S808 and the processes are repeated. At this time, a PDL command 2407 has been stored in the PDL command area 703.

In step S808, if all of the received PDL commands have completely been analyzed, step S817 follows. In step S817, whether or not a count value of the spot color counter is equal to 0 is confirmed. If it is not equal to 0, step S818 follows. At this time, the data 1506 expressed by the PDL command 2407 has been stored in the PDL command area 703 in the memory 701 and data 2707 expressed by the PDL command 2403 or data 2708 expressed by the PDL command 2405 has been stored in the spot color PDL command area 704, respectively.

In step S818, the sheet designation of the PDL command in the PDL command area 703 in the memory 701 is reset into the sheet feeding stage designation and step S819 follows. At this time, the sheet feeding stage designation “PaperFeed” of the PDL command 2407 in the PDL command area 703 is changed from “1” to “2” and stored into a PDL command 2409. The sheet feeding stage designation “PaperFeed” of the PDL command 2405 in the spot color PDL command area 704 is changed from “1” to “2” and stored into a PDL command 2408. In step S819, the spot color of the spot color PDL command area 704 is converted into a combination of CMYK by a spot/CMYK converting unit 709 on the basis of the spot color list 2500. Further, a print image is formed by an image forming unit 712 on the basis of the PDL command and is printed (the toner images of CMYK which have been converted are transferred and fixed) by the print unit 713, and step S820 follows. At this time, the data 2707 expressed by the PDL command 2403 is converted into a cyan color 2711, a magenta color 2712, a yellow color 2713, and a black color 2714 and an output result 2715 is obtained. The output result 2715 is a printed matter in which the toner images corresponding to the cyan color 2711, magenta color 2712, yellow color 2713, and black color 2714 have been printed onto the recording paper.

In step S820, the spot color counter is counted down by 1 and step S821 follows. In step S821, the spot color print start button 2801 (FIG. 28) is displayed to a user interface 710. Whether or not an output result 2716 has been set into the sheet feeding stage of a sheet feeding unit 711, and the spot color print start button 2801 has been depressed is confirmed. If NO, the processes are repeated. On the other hand, if the output result 2716 has been set to the sheet feeding stage and the spot color print start button 2801 has been depressed in step S821, the processing routine is returned to step S817 and the processes are repeated. At this time, in the processes of the second time, the data 2708 expressed by the PDL command 2408 is converted into a cyan color 2717, a magenta color 2718, a yellow color 2719, and a black color 2720 and an output result 2721 is obtained.

In step S817, whether or not the count value of the spot color counter 705 in the memory 701 is equal to 0 is confirmed. If it is equal to 0, step S824 follows. In step S824, a print image is formed by an image forming unit 712 on the basis of the PDL command 2409 in the PDL command area 703 in the memory 701 and is printed by the print unit 713, and the processing routine is finished. At this time, data 2709 expressed by the PDL command 2409 is converted into a cyan color 2725, a magenta color 2726, a yellow color 2727, and a black color 2728 and an output result 2729 printed on an output result 2724 existing in the sheet feeding unit 711 is obtained. That is, the toner images corresponding to the cyan color 2725, magenta color 2726, yellow color 2727, and black color 2729 are formed on the output result 2724, and the output result 2729 is obtained. Therefore, the output result 2729 is constructed by spot color areas 2730 and 2732, a normal color area 2731, and their overlapped areas 2733 and 2734. Or, if the count value of the spot color counter 705 is equal to 0 from the beginning, a process in which although the overprint has been designated, no spot color is contained is executed and the overprint of both normal colors in FIG. 12 is executed. In this instance, the data 1201 expressed by the PDL command 1904 has been stored in the PDL command area 703. The image of the cyan color 1206, magenta color 1207, yellow color 1208, and black color 1209 is formed by the image forming unit, toner images of the respective colors are printed by the print unit 713 onto the input sheet 1205 which is fed from the sheet feeding unit 711, and the output result 1210 is obtained. The output result 1210 is constructed by the normal colors 1212 and 1211 and the area 1213 in which both of those colors are overlaid.

If it is determined in step S806 that the overprint is not designated, step S822 follows. In step S822, commands of all object portions are copied into the PDL command area 703 in the memory 701 and step S823 follows. In step S823, if the spot color has been designated in the PDL command stored in the PDL command area 703, the spot color is separated into a cyan color, a magenta color, a yellow color, and a black color by the spot/CMYK converting unit 709. The obtained CMYK colors are synthesized with the object of normal colors and are overwritten. After that, step S824 follows. At this time, the data 1301 expressed by the PDL command 2002 has been stored in the PDL command area 703. The image of the cyan color 1305, magenta color 1306, yellow color 1307, and black color 1308 is formed by the image forming unit. Further, toner images of the respective colors are printed onto the input sheet 1304 by the print unit 713, and the output result 1309 is obtained. The output result 1309 is constructed by the spot color area 1311 and the normal color area 1310. Or, if no spot color is contained, nothing is executed in step S823. At this time, the data 1101 expressed by the PDL command 1802 has been stored in the PDL command area 703. The image of the cyan color 1105, magenta color 1106, yellow color 1107, and black color 1108 is formed by the image forming unit. Further, toner images of the respective colors are printed onto the input sheet 1104 by the print unit 713, and the output result 1109 is obtained. The output result 1109 is constructed by the normal colors 1111 and 1110.

### Fifth Embodiment

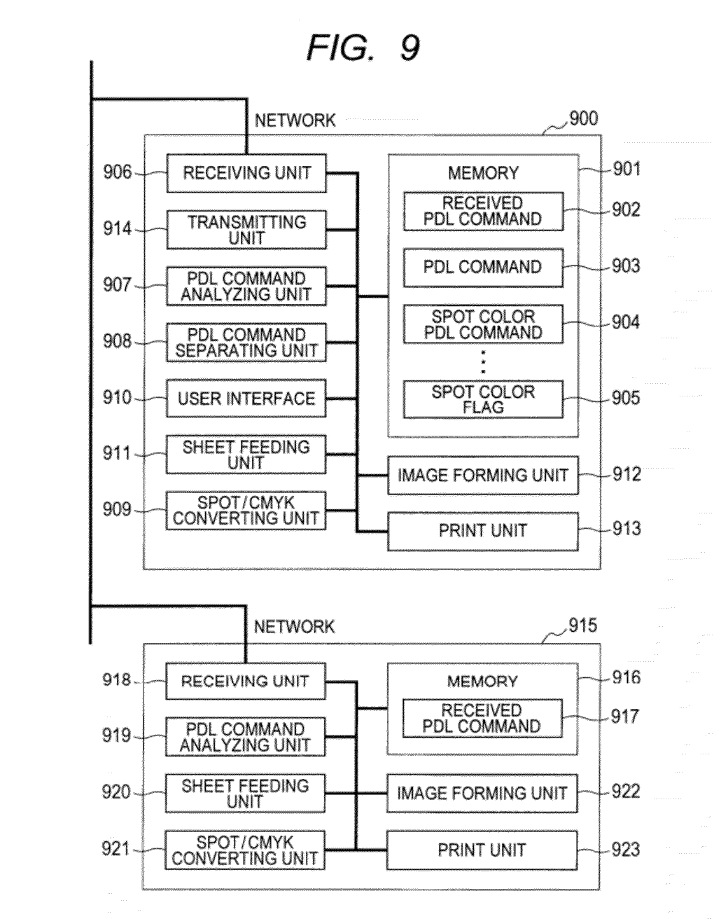

An image processing apparatus according to the fifth embodiment of the invention will be described. FIG. 9 is a system constructional diagram of the embodiment and illustrates an example in which two printers are connected so that a continuous sheet feeding and a continuous printing can be performed. The system is constructed by two systems 900 and 915.

The system 900 is constructed by a memory 901, a receiving unit 906, a PDL command analyzing unit 907, a PDL command separating unit 908, a spot/CMYK converting unit 909, a user interface 910, a sheet feeding unit 911, an image forming unit 912, a print unit 913, and a transmitting unit 914. The memory 901 has a received PDL command area 902 for storing a received PDL command, a PDL command area 903 for storing a separated PDL command, and a spot color PDL command area 904 for storing a PDL command consisting of a separated spot color. The memory 901 further has a spot color flag area 905 for showing whether or not the spot color is included in the received PDL command. The receiving unit 906 receives the PDL command through a network. The PDL command analyzing unit 907 analyzes the received PDL command. The PDL command separating unit 908 separates the received PDL command into the spot color and the other colors. The spot/CMYK converting unit 909 divides the spot color into one or more colors among the CMYK colors. The user interface 910 receives an instruction from the user. The sheet feeding unit 911 receives a print sheet. The image forming unit 912 forms print data from the PDL command or spot color PDL command. The print unit 913 prints an image formed by the image forming unit. The transmitting unit 914 transmits the PDL command.

The other system 915 is constructed by a memory 916, a receiving unit 918, a PDL command analyzing unit 919, a sheet feeding unit 920, a spot/CMYK converting unit 921, an image forming unit 922, and a print unit 923. The memory 916 has a received PDL command area 917 for storing a received PDL command. The receiving unit 918 receives the PDL command through a network. The PDL command analyzing unit 919 analyzes the received PDL command. The sheet feeding unit 920 receives a print sheet. The spot/CMYK converting unit 921 divides the spot color into one or more colors among the CMYK colors. The image forming unit 922 forms print data from the PDL command. The print unit 923 prints an image formed by the image forming unit.

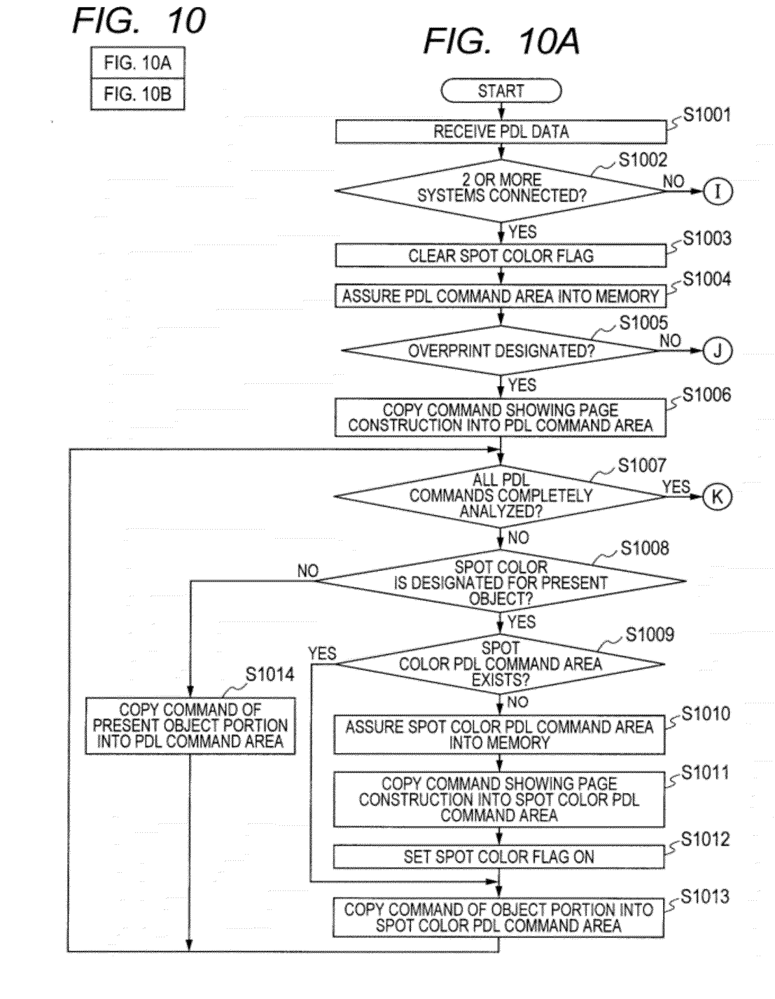

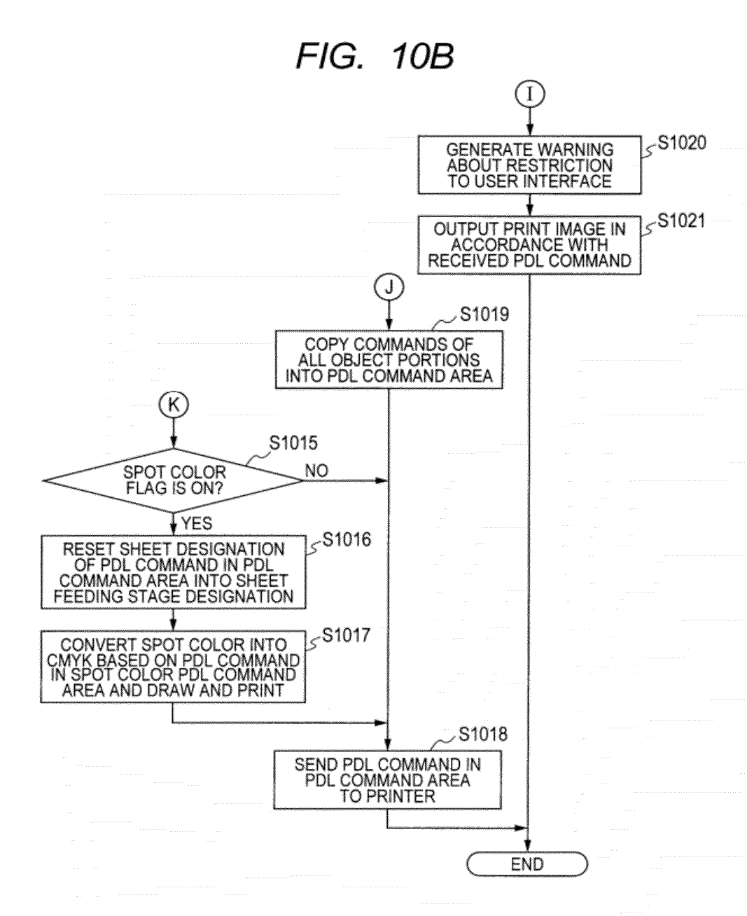

FIGS. 10A and 10B are flowcharts illustrating a flow which is executed until an image is printed by the print unit 913 and the PDL command is transmitted to the system 915 after the PDL command was received by the receiving unit 906. FIGS. 11 to 15 are the diagrams for describing a change in image in the flow of those processes. FIG. 17 is the diagram for describing the drawing diagram of the PDL command 1801. FIGS. 18 to 24 are the diagrams for describing a change in image in PDL command in the flow of those processes. FIG. 25 is the diagram for describing the reference list for converting a spot color into colors of CMYK. Processes which are executed in the system 915 correspond to the processes obtained by reducing the processes which are executed in the system 900 and their description is omitted here.

In step S1001 in FIGS. 10A and 10B, the PDL command is received by the receiving unit 906, the received PDL command is stored into the received PDL command area 902 in the memory 901, and the processing routine advances to step S1002. At this time, one of the PDL commands 1801 (FIG. 18), 1901 (FIG. 19), 2001 (FIG. 20), and 2101 (FIG. 21) has been stored in the received PDL command area 902. In step S1002, whether or not two or more systems have been connected is discriminated. If it is determined that two or more systems have been connected, step S1003 follows. In step S1003, the spot color flag 905 in the memory 901 is cleared and step S1004 follows. In step S1004, the PDL command area 903 is assured in the memory 901 and step S1005 follows.

In step S1005, the received PDL command stored in the received PDL command area is analyzed by the PDL command analyzing unit 907, whether or not the overprint has been designated is confirmed, and if the overprint has been designated, step S1006 follows. That is, if “Overprint” in one of the PDL commands 1801, 1901, 2001, and 2101 stored in the received PDL command area 902 is “ON”, step S1006 follows. In step S1006, the received PDL command stored in the received PDL command area is analyzed by the PDL command analyzing unit 907, the command showing a construction of a page is copied into the assured PDL command area 903, and step S1007 follows. At this time, one of the PDL commands 1902 and 2105 has been stored in the PDL command area 903. In step S1007, whether or not all of the received PDL commands stored in the received PDL command area have completely been analyzed by the PDL command analyzing unit 907 is confirmed. If all of the received PDL commands are not analyzed yet, step S1008 follows.

In step S1008, whether or not the spot color has been designated for the present object which is being analyzed is discriminated. If the spot color has been designated, step S1009 follows. In step S1009, whether or not the spot color PDL command area has already been assured in the memory 901 is confirmed. If it is not assured yet, step S1010 follows. In step S1010, the spot color PDL command area 904 is assured in the memory 901 and step S1011 follows. In step S1011, the received PDL command stored in the received PDL command area is analyzed by the PDL command analyzing unit 907, the command showing the page construction is copied into the assured spot color PDL command area 904, and step S1012 follows. At this time, the PDL command 2102 has been stored in the spot color PDL command area 904.

In step S1012, the spot color flag 905 in the memory 901 is set to ON and step S1013 follows. In step S1013, the command in the object portion which is at present being analyzed is copied into the spot color PDL command area 904 by the PDL command separating unit 908. The processing routine is returned to step S1007 and the processes are repeated. At this time, the PDL command 2103 has been stored in the spot color PDL command area 904.

In step S1009, if the spot color PDL command area 904 has already been assured in the memory 901, step S1013 follows. In step S1008, if the spot color is not designated for the present object which is being analyzed, step S1014 follows. In step S1014, the command in the object portion which is at present being analyzed is copied into the PDL command area 903 by the PDL command separating unit 908. The processing routine is returned to step S1007 and the processes are repeated. At this time, the PDL command 2106 has been stored in the spot color PDL command area 904.

If all of the received PDL commands have completely been analyzed in step S1007, step S1015 follows. In step S1015, whether or not the spot color flag in the memory 901 is ON is discriminated. If the spot color flag is ON, step S1016 follows. At this time, the data 1506 expressed by the PDL command 2106 has been stored in the PDL command area 903 in the memory 901 and the data 1505 expressed by the PDL command 2103 has been stored in the spot color PDL command area 904, respectively.

In step S1016, the sheet designation “PaperFeed” of the PDL command 2106 in the PDL command area 903 in the memory 901 is reset from “1” to “2” and is stored as a PDL command 2107, and step S1017 follows. In step S1017, the spot color of the spot color PDL command area 904 is converted into a combination of CMYK by the spot/CMYK converting unit 909 on the basis of the spot color list 2500. Further, a print image is formed by an image forming unit 912 on the basis of the PDL command and is printed (the toner images of CMYK which have been converted are transferred and fixed) by the print unit 913, and step S1018 follows. At this time, the data 1505 expressed by the PDL command 2103 is converted into the cyan color 1508, magenta color 1509, yellow color 1510, and black color 1511 and the output result 1512 is obtained. The output result 1512 is a printed matter in which the toner images corresponding to the cyan color 1508, magenta color 1509, yellow color 1510, and black color 1511 have been printed onto the recording paper.

In step S1018, the PDL command 2107 stored in the PDL command area 903 is transmitted to the other system 915 through the transmitting unit 914. At this time, the data 1506 expressed by the PDL command 2107 which is transmitted is expressed by the cyan color 1514, magenta color 1515, yellow color 1516, and black color 1517 in the system 915. Further, the sheet feeding unit 920 feeds the recording paper on which the output result 1512 of the system 900 has been printed, and prints the toner images corresponding to the cyan color 1508, magenta color 1509, yellow color 1510, and black color 1511 onto the output result 1512, thereby obtaining the output result 1518. The output result 1518 is constructed by the spot color area 1520, the normal color area 1519, and the area 1521 in which both of those areas are overlaid.

In step S1015, if the spot color flag is OFF, step S1018 follows. At this time, a process in which although the overprint has been designated, no spot color is contained is executed. The overprint of both normal colors in FIG. 12 is performed. In this instance, the data 1201 expressed by the PDL command 1904 has been stored in the received PDL command area 917. An image of the cyan color 1206, magenta color 1207, yellow color 1208, and black color 1209 is formed by the image forming unit 922, toner images of the respective colors are printed by the print unit 923 onto the input sheet 1205 which is fed into the sheet feeding unit 920, and the output result 1210 is obtained. The output result 1210 is constructed by the normal colors 1212 and 1211 and the area 1213 in which both of those colors are overlaid.

If it is determined in step S1005 that the overprint is not designated, step S1019 follows. In step S1019, the commands of all object portions are copied into the PDL command area 903 in the memory 901 and step S1018 follows. At this time, the data 1301 expressed by the PDL command 2002 has been stored in the received PDL command area 917. If the spot color has been designated in the PDL command, the spot color is separated into a cyan color, a magenta color, a yellow color, and a black color by the spot/CMYK converting unit 921 on the basis of the spot color list 2500. The obtained CMYK colors are synthesized with an object of normal colors and are overwritten. Thus, an image of the cyan color 1305, magenta color 1306, yellow color 1307, and black color 1308 is formed by the image forming unit 922, toner images of the respective colors are printed onto the input sheet 1304 by the print unit 923, and the output result 1309 is obtained. The output result 1309 is constructed by the spot color area 1311 and the normal color area 1310. Or, if no spot color is contained, the data 1101 expressed by the PDL command 1802 has been stored in the received PDL command area 917. Thus, an image of the cyan color 1105, magenta color 1106, yellow color 1107, and black color 1108 is formed by the image forming unit, toner images of the respective colors are printed onto the input sheet 1104 by the print unit 923, and the output result 1109 is obtained. The output result 1109 is constructed by the normal colors 1111 and 1110.

If it is determined in step S1002 that one system has been connected, step S1020 follows. In step S1020, such a warning that if the spot-color-designated object exists and the overprint has been designated, there is a case where a part of the spot color cannot be accurately reproduced is displayed to the user interface 910, and step S1021 follows. In step S1021, a print image is formed by the image forming unit 912 on the basis of the PDL command of the received PDL command area 902 and is printed by the print unit 913. The processing routine is finished.

### Other Embodiments

The invention is also realized by executing the following processes. That is, software (program) for realizing the functions of the embodiments mentioned above is supplied to a system or an apparatus through a network or various kinds of storage media, a computer (or a CPU, MPU, or the like) of the system or apparatus reads out the program and executes processes corresponding to the program.

In the printing apparatus which expresses the spot color by CMYK, if the overprint was designated, the object for which the spot color has been designated is separated into PDL commands of (the number of designated spot colors+1) for every kind of spot color and the other objects, and the printing is repeated a plurality of number of times.

Thus, in the printing apparatus which expresses the spot color by CMYK, in the case where the overprint was designated and both of the spot colors are overlaid or the spot color and other colors are overlaid, even a portion in which a color material is expressed in excess of 100% can be accurately printed.

In other words, the toner of each color can be overlaid in excess of 100% and the overprint of the spot color can be reproduced in a form of an output result closer to that of the printer.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2011-088861, filed Apr. 13, 2011, which is hereby incorporated by reference herein in its entirety.

What is claimed is:

1. An image forming apparatus comprising:
a receiving unit configured to receive a print command;
an analyzing unit configured to analyze the print command received by the receiving unit;
a converting unit configured to convert the received print command into CMYK when the analysis by the analyzing unit shows that a spot color is designated for the received print command; and
an image forming unit configured to print an image of the CMYK converted by the converting unit onto a recording paper and to print an image of CMYK obtained based on one of the received print commands for which no spot color is designated onto the recording paper.

2. The apparatus according to claim 1, wherein the image forming unit comprises a first image forming unit configured to print the image of the CMYK converted by the converting unit and a second image forming unit configured to print the image of the CMYK obtained based on one of the received print commands for which no spot color is designated.

3. The apparatus according to claim 1, wherein the print command for which the spot color is designated and the print command for which no spot color is designated are set to correspond to each other by IDs.

4. An image forming method comprising:
receiving a print command;
analyzing the received print command;
converting the received print command into CMYK when the analysis in the analyzing shows that a spot color is designated for the received print command; and
forming an image by printing an image of the converted CMYK onto a recording paper and by printing an image of CMYK obtained based on one of the received print commands for which no spot color is designated onto the recording paper.

5. The method according to claim 4, wherein the forming prints the image of the converted CMYK and the image of the CMYK obtained based on one of the received print commands for which no spot color is designated using respective different image forming units.

6. The method according to claim 4, wherein the print command for which the spot color is designated and the print command for which no spot color is designated are set to correspond to each other by IDs.

7. A non-transitory computer-readable storage medium storing a computer program for executing the method according to claim 4.
